(19) United States
(12) Patent Application Publication
(10) Pub. No.: US 2023/0130569 A1
(43) Pub. Date: Apr. 27, 2023

(54) WIRELESS COMMUNICATION TERMINAL AND METHOD FOR TRANSMITTING OR RECEIVING DATA IN WIRELESS COMMUNICATION SYSTEM

(71) Applicant: WILUS INSTITUTE OF STANDARDS AND TECHNOLOGY INC., Gyeonggi-do (KR)

(72) Inventors: Sanghyun KIM, Seoul (KR); Juhyung SON, Gyeonggi-do (KR); Geonjung KO, Gyeonggi-do (KR); Jinsam KWAK, Gyeonggi-do (KR)

(21) Appl. No.: 17/911,635

(22) PCT Filed: Mar. 15, 2021
(86) PCT No.: PCT/KR2021/003186

§ 371 Date: Sep. 14, 2022

(30) Foreign Application Priority Data
Mar. 14, 2020 (KR) 10-2020-0031650
Jun. 23, 2020 (KR) 10-2020-0076814

(51) Int. Cl. H04L 5/00; H04W 72/0453

(52) U.S. Cl. CPC H04L 5/0053; H04W 72/0453

(57) ABSTRACT

Disclosed is a method for transmitting or receiving a TB PPDU based on a trigger frame in a wireless communication system. A terminal receives a trigger frame from an access point (AP) and transmits a response frame in response to the trigger frame. The response frame may be generated on the basis of information obtained from a first plurality of spatial reuse fields or a second plurality of spatial reuse fields of the trigger frame according to a resource unit and/or a format of the response frame.

### TECHNICAL FIELD

The present invention relates to a wireless communication system and, more specifically, to a method and device for transmitting/receiving and configuring a trigger frame for indicating transmission of a trigger-based (TB) physical layer protocol data unit (PPDU) and a trigger frame-based TB PPDU in a wireless communication system.

### BACKGROUND ART

In recent years, with supply expansion of mobile apparatuses, a wireless LAN technology that can provide a rapid wireless Internet service to the mobile apparatuses has been significantly spotlighted. The wireless LAN technology allows mobile apparatuses including a smart phone, a smart pad, a laptop computer, a portable multimedia player, an embedded apparatus, and the like to wirelessly access the Internet in home or a company or a specific service providing area based on a wireless communication technology in a short range.

Institute of Electrical and Electronics Engineers (IEEE) 802.11 has commercialized or developed various technological standards since an initial wireless LAN technology is supported using frequencies of 2.4 GHz. First, the IEEE 802.11b supports a communication speed of a maximum of 11 Mbps while using frequencies of a 2.4 GHz band. IEEE 802.11a which is commercialized after the IEEE 802.11b uses frequencies of not the 2.4 GHz band but a 5 GHz band to reduce an influence by interference as compared with the frequencies of the 2.4 GHz band which are significantly congested and improves the communication speed up to a maximum of 54 Mbps by using an OFDM technology. However, the IEEE 802.11a has a disadvantage in that a communication distance is shorter than the IEEE 802.11b. In addition, IEEE 802.11g uses the frequencies of the 2.4 GHz band similarly to the IEEE 802.11b to implement the communication speed of a maximum of 54 Mbps and satisfies backward compatibility to significantly come into the spotlight and further, is superior to the IEEE 802.11a in terms of the communication distance.

Moreover, as a technology standard established to overcome a limitation of the communication speed which is pointed out as a weak point in a wireless LAN, IEEE 802.11n has been provided. The IEEE 802.11n aims at increasing the speed and reliability of a network and extending an operating distance of a wireless network. In more detail, the IEEE 802.11n supports a high throughput (HT) in which a data processing speed is a maximum of 540 Mbps or more and further, is based on a multiple inputs and multiple outputs (MIMO) technology in which multiple antennas are used at both sides of a transmitting unit and a receiving unit in order to minimize a transmission error and optimize a data speed. Further, the standard can use a coding scheme that transmits multiple copies which overlap with each other in order to increase data reliability.

As the supply of the wireless LAN is activated and further, applications using the wireless LAN are diversified, the need for new wireless LAN systems for supporting a higher throughput (very high throughput (VHT)) than the data processing speed supported by the IEEE 802.11n has come into the spotlight. Among them, IEEE 802.11ac supports a wide bandwidth (80 to 160 MHz) in the 5 GHz frequencies. The IEEE 802.11ac standard is defined only in the 5 GHz band, but initial 11ac chipsets will support even operations in the 2.4 GHz band for the backward compatibility with the existing 2.4 GHz band products. Theoretically, according to the standard, wireless LAN speeds of multiple stations are enabled up to a minimum of 1 Gbps and a maximum single link speed is enabled up to a minimum of 500 Mbps. This is achieved by extending concepts of a wireless interface accepted by 802.11n, such as a wider wireless frequency bandwidth (a maximum of 160 MHz), more MIMO spatial streams (a maximum of 8), multi-user MIMO, and high-density modulation (a maximum of 256 QAM). Further, as a scheme that transmits data by using a 60 GHz band instead of the existing 2.4 GHz/5 GHz, IEEE 802.11ad has been provided. The IEEE 802.11ad is a transmission standard that provides a speed of a maximum of 7 Gbps by using a beamforming technology and is suitable for high bit rate moving picture streaming such as massive data or non-compression HD video. However, since it is difficult for the 60 GHz frequency band to pass through an obstacle, it is disadvantageous in that the 60 GHz frequency band can be used only among devices in a short-distance space.

As a wireless LAN standard after 802.11ac and 802.11ad, the IEEE 802.11ax (high efficiency WLAN, HEW) standard for providing a high-efficiency and high-performance wireless LAN communication technology in a high-density environment, in which APs and terminals are concentrated, is in the development completion stage. In an 802.11ax-based wireless LAN environment, communication with high frequency efficiency should be provided indoors/outdoors in the presence of high-density stations and access points (APs), and various technologies have been developed to implement the same.

In order to support new multimedia applications, such as high-definition video and real-time games, the development of a new wireless LAN standard has begun to increase a maximum transmission rate. In IEEE 802.11be (extremely high throughput, EHT), which is a 7th generation wireless LAN standard, development of standards is underway aiming at supporting a transmission rate of up to 30 Gbps via a wider bandwidth, an increased spatial stream, multi-AP cooperation, and the like in a 2.4/5/6 GHz band.

### DISCLOSURE OF INVENTION

### Technical Problem

An aspect of the present invention is to provide a high-speed wireless LAN service for a new multimedia application, as described above.

In addition, the present invention is to provide a method and device for configuring a trigger frame for indicating transmission of a TB PPDU corresponding to a PPDU based on the trigger frame, according to a type.

In addition, the present invention is to provide a method and device for generating a high efficiency (HE) PPDU or an extremely high throughput (EHT) PPDU according to different information included a trigger frame transmitted from an access point (AP).

Technical tasks to be achieved in the specification are not limited to the technical tasks mentioned above, and other technical tasks that are not mentioned may be clearly understood by those skilled in the art on the basis of the following descriptions.

### Solution to Problem

A terminal for transmitting a trigger-based physical layer protocol unit (TB PPDU) corresponding to a response frame on the basis of a trigger frame in a wireless communication system includes: a communication module; and a processor configured to control the communication module, wherein the processor: receives a trigger frame from an access point (AP) wherein the trigger frame includes a common information field including first multiple spatial reuse fields, and whether the trigger frame includes an additional information field including second multiple spatial reuse fields is identified on the basis of identification information of the trigger frame; and transmits a response frame generated on the basis of information acquired from the first multiple spatial reuse fields or the second multiple spatial reuse fields, as a response to the trigger frame, and whether the response frame is generated on the basis of the first multiple spatial reuse fields or is generated on the basis of the second multiple spatial reuse fields is determined on the basis of a format related to the trigger frame.

In addition, in the present invention, when the format related to the trigger frame is an extremely high throughput (EHT) format, the response frame is generated on the basis of information acquired from the second multiple spatial reuse fields

In addition, in the present invention, when the format related to the trigger frame is a high efficiency (HE) format, the response frame is generated on the basis of information acquired from the first multiple spatial reuse fields.

In addition, in the present invention, whether the response frame is generated on the basis of the information acquired from the first multiple spatial reuse fields or is generated on the basis of the information acquired from the second multiple spatial reuse fields is determined on the basis of a location on a frequency axis of a resource unit in which the response frame is transmitted.

In addition, in the present invention, the trigger frame further includes a bandwidth field, an additional bandwidth field, and a resource allocation field indicating a resource unit in which the response frame is transmitted.

In addition, in the present invention, the processor recognizes, on the basis of the resource allocation field, the resource unit in which the response frame is transmitted, and generates a response frame on the basis of the information acquired from the first multiple spatial reuse fields or the second multiple spatial reuse fields according to a location on a frequency axis of the resource unit in which the response frame is transmitted.

In addition, in the present invention, the trigger frame further includes a puncturing mode field indicating whether puncturing in a bandwidth indicated by the bandwidth field and/or the additional bandwidth field is performed and a location of the puncturing.

In addition, in the present invention, when the response frame is generated on the basis of the second multiple spatial reuse fields, the response frame is transmitted through a bandwidth indicated by a bandwidth field included in the common information field and an additional bandwidth field included in the additional information field.

In addition, in the present invention, the response frame includes multiple spatial reuse fields, and each of the multiple spatial reuse fields is configured on the basis of information acquired from each of the corresponding first multiple spatial reuse fields or the second multiple spatial reuse fields.

In addition, in the present invention, whether the trigger frame includes the additional information field is recognized according to whether a value of a specific subfield of the common information field, indicating whether the additional information field is included, and/or a value of an identifier of the additional information field is configured as a specific value.

In addition, in the present invention, the response frame is a trigger-based physical layer protocol data unit (TB PPDU), the TB PPDU is aggregated with at least one TB PPDU transmitted from at least one another terminal for which TB PPDU transmission is indicated by the trigger frame, and is transmitted in an aggregated (A)-PPDU format, the at least one TB PPDU is generated on the basis of the first multiple spatial reuse fields or the second multiple spatial reuse fields, and the TB PPDU and the at least one TB PPDU are generated on the basis of different spatial reuse fields.

In addition, the present invention provides a method including: receiving a trigger frame from an access point (AP), wherein the trigger frame includes a common information field including first multiple spatial reuse fields, and whether the trigger frame includes an additional information field including second multiple spatial reuse fields is identified on the basis of identification information of the trigger frame; and transmitting a response frame generated on the basis of information acquired from the first multiple spatial reuse fields or the second multiple spatial reuse fields, as a response to the trigger frame, wherein whether the response frame is generated on the basis of the first multiple spatial reuse fields or is generated on the basis of the second multiple spatial reuse fields is determined on the basis of a format related to the trigger frame.

### Advantageous Effects of Invention

According to an embodiment of the present invention, by including information for generation of TB PPDUs having different formats in different fields and transmitting the same through a trigger frame, transmission of TB PPDUs having multiple formats can be indicated through single signaling.

In addition, according to an embodiment of the present invention, information for spatial reuse for TB PPDUs having different formats is included in different fields of a trigger frame according to each of the formats, and is transmitted, resolution of spatial reuse shown in the TB PPDU can be increased.

In addition, according to an embodiment of the present invention, as the resolution of the spatial reuse shown in the TB PPDU is increased, spatial reuse efficiency of an overlapping basic service set (OBSS) can be increased.

In addition, according to an embodiment of the present invention, as a trigger frame is transmitted through a discontinuous channel, TB PPDU transmission can be allowed for multiple STAs.

The effects obtainable in the present invention are not limited to the above-mentioned effects, and other effects that are not mentioned may be clearly understood by those skilled in the art to which the present invention belongs, from descriptions below.

### BRIEF DESCRIPTION OF DRAWINGS

FIG. 1 illustrates a wireless LAN system according to an embodiment of the present invention.

FIG. 2 illustrates a wireless LAN system according to another embodiment of the present invention.

FIG. 3 illustrates a configuration of a station according to an embodiment of the present invention.

FIG. 4 illustrates a configuration of an access point according to an embodiment of the present invention.

FIG. 5 schematically illustrates a process in which a STA and an AP set a link.

FIG. 6 illustrates a carrier sense multiple access (CSMA)/collision avoidance (CA) method used in wireless LAN communication.

FIG. 7 illustrates a PPDU format of an extremely high throughput (EHT) Wireless LAN according to an embodiment of the present disclosure;

FIG. 8 illustrates a U-SIG field of an TB PPDU according to an embodiment of the present disclosure;

FIG. 9 illustrates an example of a trigger format according to an embodiment of the present invention.

FIG. 10 illustrates an example of a configuration of a common information field of a trigger frame according to an embodiment of the present invention.

FIG. 11 illustrates an example of a configuration of an additional information field according to a format of a trigger frame according to an embodiment of the present invention.

FIG. 12 illustrates an example of a spatial reuse field and a puncturing mode field for uplink transmission according to an embodiment of the present invention.

FIG. 13 illustrates an example of transmission of a trigger frame-based TB PPDU and a trigger frame according to an embodiment of the present invention.

FIGS. 14A and 14B illustrate another example of transmission of a trigger frame-based TB PPDU and a trigger frame according to an embodiment of the present invention.

FIG. 15 is a flowchart illustrating a method for selecting a spatial reuse field for generation of a TB PPDU on the basis of a trigger frame according to an embodiment of the present invention.

FIG. 16 illustrates an example of a spatial reuse operation according to the number of spatial reuse fields for a frequency band according to an embodiment of the present invention.

FIG. 17 illustrates an example of a trigger frame transmission method according to an embodiment of the present invention.

FIG. 18 illustrates an example of a TB PPDU including a puncturing mode according to an embodiment of the present invention.

FIG. 19 illustrates an example of a procedure of responding a TB PPDU and allocating a resource unit through a trigger frame according to an embodiment of the present invention.

FIG. 20 illustrates an example of a method for receiving a TB PPDU on the basis of a trigger frame according to an embodiment of the present invention.

FIG. 21 illustrates another example of a method for receiving a TB PPDU on the basis of a trigger frame according to an embodiment of the present invention.

FIG. 22 illustrates another example of a method for receiving a TB PPDU on the basis of a trigger frame according to an embodiment of the present invention.

FIG. 23 illustrates another example of a method for receiving a TB PPDU on the basis of a trigger frame according to an embodiment of the present invention.

FIG. 24 illustrates an example of a user information field of a trigger frame according to an embodiment of the present invention.

FIG. 25 illustrates an example of a method for transmitting a TB PPDU on the basis of a trigger frame according to an embodiment of the present invention.

FIG. 26 illustrates an example of a format of a U-SIG field of a TB PPDU according to an embodiment of the present invention.

FIG. 27 illustrates an example of signaling and configuration of a resource unit for TB PPDU transmission according to an embodiment of the present invention.

FIG. 28 illustrates an example of signaling of a puncturing mode and a segment location through a TB PPDU according to an embodiment of the present invention.

FIG. 29 illustrates an example of configuration and use of a subchannel for TB PPDU transmission according to an embodiment of the present invention.

FIG. 30 illustrates an example of signal detection for a TB PPDU as a response to a trigger frame according to an embodiment of the present invention.

FIG. 31 illustrates an example of applying different threshold values to an area in which reception is predicted in a signal detection process for a TB PPDU according to an embodiment of the present invention.

FIG. 32 illustrates an example of an error correction method for signal detection according to an embodiment of the present invention.

FIG. 33 is a flowchart illustrating an example of a method for transmitting a response frame to a trigger frame by a non-AP STA according to an embodiment of the present invention.

FIG. 34 is a flowchart illustrating an example of a method for receiving a response frame to a trigger frame by an AP STA according to an embodiment of the present invention.

### BEST MODE FOR CARRYING OUT THE INVENTION

Terms used in the specification adopt general terms which are currently widely used by considering functions in the present invention, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

Throughout this specification and the claims that follow, when it is described that an element is “coupled” to another element, the element may be “directly coupled” to the other element or “electrically coupled” to the other element through a third element. Further, unless explicitly described to the contrary, the word “comprise” and variations such as “comprises” or “comprising”, will be understood to imply the inclusion of stated elements but not the exclusion of any other elements. Moreover, limitations such as “or more” or “or less” based on a specific threshold may be appropriately substituted with “more than” or “less than”, respectively. Hereinafter, in the present invention, a field and a subfield may be interchangeably used.

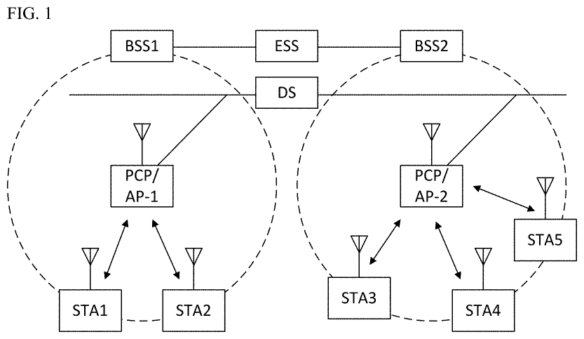

FIG. 1 illustrates a wireless LAN system according to an embodiment of the present invention.

FIG. 1 is a diagram illustrating a wireless LAN system according to an embodiment of the present invention. The wireless LAN system includes one or more basic service sets (BSS) and the BSS represents a set of apparatuses which are successfully synchronized with each other to communicate with each other. In general, the BSS may be classified into an infrastructure BSS and an independent BSS (IBSS) and FIG. 1 illustrates the infrastructure BSS between them.

As illustrated in FIG. 1, the infrastructure BSS (BSS1 and BSS2) includes one or more stations STA1, STA2, STA3, STA4, and STA5, access points AP-1 and AP-2 which are stations providing a distribution service, and a distribution system (DS) connecting the multiple access points AP-1 and AP-2.

The station (STA) is a predetermined device including medium access control (MAC) following a regulation of an IEEE 802.11 standard and a physical layer interface for a wireless medium, and includes both a non-access point (non-AP) station and an access point (AP) in a broad sense. Further, in the present specification, a term ‘terminal’ may be used to refer to a non-AP STA, or an AP, or to both terms. A station for wireless communication includes a processor and a communication unit and according to the embodiment, may further include a user interface unit and a display unit. The processor may generate a frame to be transmitted through a wireless network or process a frame received through the wireless network and besides, perform various processing for controlling the station. In addition, the communication unit is functionally connected with the processor and transmits and receives frames through the wireless network for the station. According to the present invention, a terminal may be used as a term which includes user equipment (UE).

The access point (AP) is an entity that provides access to the distribution system (DS) via wireless medium for the station associated therewith. In the infrastructure BSS, communication among non-AP stations is, in principle, performed via the AP, but when a direct link is configured, direct communication is enabled even among the non-AP stations. Meanwhile, in the present invention, the AP is used as a concept including a personal BSS coordination point (PCP) and may include concepts including a centralized controller, a base station (BS), a node-B, a base transceiver system (BTS), and a site controller in a broad sense. In the present invention, an AP may also be referred to as a base wireless communication terminal. The base wireless communication terminal may be used as a term which includes an AP, a base station, an eNB (i.e. eNodeB) and a transmission point (TP) in a broad sense. In addition, the base wireless communication terminal may include various types of wireless communication terminals that allocate medium resources and perform scheduling in communication with a plurality of wireless communication terminals.

A plurality of infrastructure BSSs may be connected with each other through the distribution system (DS). In this case, a plurality of BSSs connected through the distribution system is referred to as an extended service set (ESS).

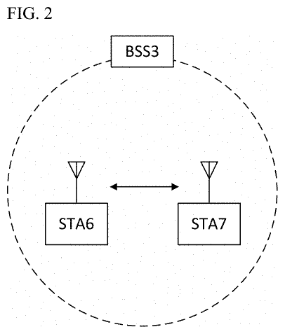

FIG. 2 illustrates an independent BSS which is a wireless LAN system according to another embodiment of the present invention. In the embodiment of FIG. 2, duplicative description of parts, which are the same as or correspond to the embodiment of FIG. 1, will be omitted.

Since a BSS3 illustrated in FIG. 2 is the independent BSS and does not include the AP, all stations STA6 and STA7 are not connected with the AP. The independent BSS is not permitted to access the distribution system and forms a self-contained network. In the independent BSS, the respective stations STA6 and STA7 may be directly connected with each other.

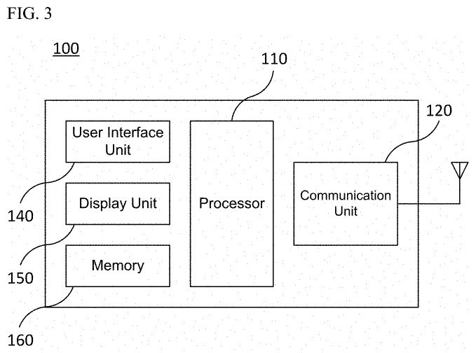

FIG. 3 is a block diagram illustrating a configuration of a station 100 according to an embodiment of the present invention. As illustrated in FIG. 3, the station 100 according to the embodiment of the present invention may include a processor 110, a communication unit 120, a user interface unit 140, a display unit 150, and a memory 160.

First, the communication unit 120 transmits and receives a wireless signal such as a wireless LAN packet, or the like and may be embedded in the station 100 or provided as an exterior. According to the embodiment, the communication unit 120 may include at least one communication module using different frequency bands. For example, the communication unit 120 may include communication modules having different frequency bands such as 2.4 GHz, 5 GHz, 6 GHz and 60 GHz. According to an embodiment, the station 100 may include a communication module using a frequency band of 7.125 GHz or more and a communication module using a frequency band of 7.125 GHz or less. The respective communication modules may perform wireless communication with the AP or an external station according to a wireless LAN standard of a frequency band supported by the corresponding communication module. The communication unit 120 may operate only one communication module at a time or simultaneously operate multiple communication modules together according to the performance and requirements of the station 100. When the station 100 includes a plurality of communication modules, each communication module may be implemented by independent elements or a plurality of modules may be integrated into one chip. In an embodiment of the present invention, the communication unit 120 may represent a radio frequency (RF) communication module for processing an RF signal.

Next, the user interface unit 140 includes various types of input/output means provided in the station 100. That is, the user interface unit 140 may receive a user input by using various input means and the processor 110 may control the station 100 based on the received user input. Further, the user interface unit 140 may perform output based on a command of the processor 110 by using various output means.

Next, the display unit 150 outputs an image on a display screen. The display unit 150 may output various display objects such as contents executed by the processor 110 or a user interface based on a control command of the processor 110, and the like. Further, the memory 160 stores a control program used in the station 100 and various resulting data. The control program may include an access program required for the station 100 to access the AP or the external station.

The processor 110 of the present invention may execute various commands or programs and process data in the station 100. Further, the processor 110 may control the respective units of the station 100 and control data transmission/reception among the units. According to the embodiment of the present invention, the processor 110 may execute the program for accessing the AP stored in the memory 160 and receive a communication configuration message transmitted by the AP. Further, the processor 110 may read information on a priority condition of the station 100 included in the communication configuration message and request the access to the AP based on the information on the priority condition of the station 100. The processor 110 of the present invention may represent a main control unit of the station 100 and according to the embodiment, the processor 110 may represent a control unit for individually controlling some component of the station 100, for example, the communication unit 120, and the like. That is, the processor 110 may be a modem or a modulator/demodulator for modulating and demodulating wireless signals transmitted to and received from the communication unit 120. The processor 110 controls various operations of wireless signal transmission/reception of the station 100 according to the embodiment of the present invention. A detailed embodiment thereof will be described below.

The station 100 illustrated in FIG. 3 is a block diagram according to an embodiment of the present invention, where separate blocks are illustrated as logically distinguished elements of the device. Accordingly, the elements of the device may be mounted in a single chip or multiple chips depending on design of the device. For example, the processor 110 and the communication unit 120 may be implemented while being integrated into a single chip or implemented as a separate chip. Further, in the embodiment of the present invention, some components of the station 100, for example, the user interface unit 140 and the display unit 150 may be optionally provided in the station 100.

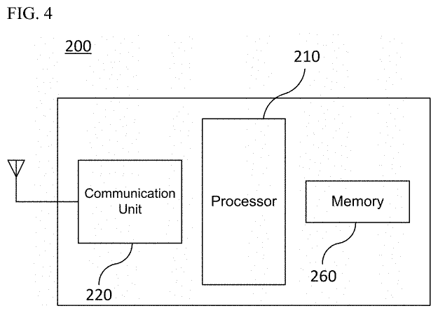

FIG. 4 is a block diagram illustrating a configuration of an AP 200 according to an embodiment of the present invention. As illustrated in FIG. 4, the AP 200 according to the embodiment of the present invention may include a processor 210, a communication unit 220, and a memory 260. In FIG. 4, among the components of the AP 200, duplicative description of parts which are the same as or correspond to the components of the station 100 of FIG. 3 will be omitted.

Referring to FIG. 4, the AP 200 according to the present invention includes the communication unit 220 for operating the BSS in at least one frequency band. As described in the embodiment of FIG. 3, the communication unit 220 of the AP 200 may also include a plurality of communication modules using different frequency bands. That is, the AP 200 according to the embodiment of the present invention may include two or more communication modules among different frequency bands, for example, 2.4 GHz, 5 GHz, 6 GHz and 60 GHz together. Preferably, the AP 200 may include a communication module using a frequency band of 7.125 GHz or more and a communication module using a frequency band of 7.125 GHz or less. The respective communication modules may perform wireless communication with the station according to a wireless LAN standard of a frequency band supported by the corresponding communication module. The communication unit 220 may operate only one communication module at a time or simultaneously operate multiple communication modules together according to the performance and requirements of the AP 200. In an embodiment of the present invention, the communication unit 220 may represent a radio frequency (RF) communication module for processing an RF signal.

Next, the memory 260 stores a control program used in the AP 200 and various resulting data. The control program may include an access program for managing the access of the station. Further, the processor 210 may control the respective units of the AP 200 and control data transmission/reception among the units. According to the embodiment of the present invention, the processor 210 may execute the program for accessing the station stored in the memory 260 and transmit communication configuration messages for one or more stations. In this case, the communication configuration messages may include information about access priority conditions of the respective stations. Further, the processor 210 performs an access configuration according to an access request of the station. According to an embodiment, the processor 210 may be a modem or a modulator/demodulator for modulating and demodulating wireless signals transmitted to and received from the communication unit 220. The processor 210 controls various operations such as wireless signal transmission/reception of the AP 200 according to the embodiment of the present invention. A detailed embodiment thereof will be described below.

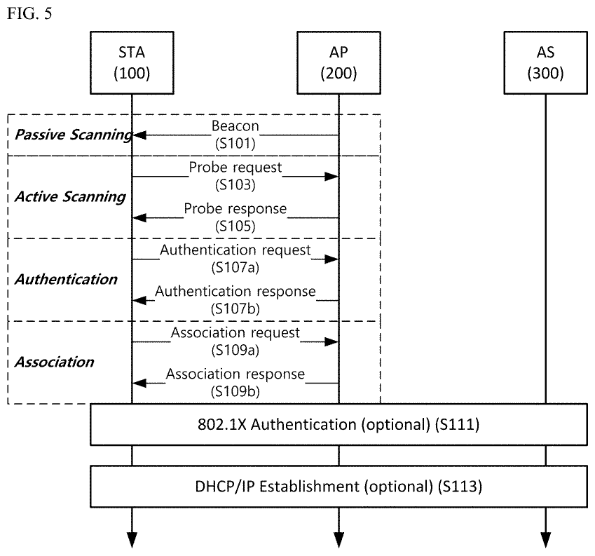

FIG. 5 is a diagram schematically illustrating a process in which a STA sets a link with an AP.

Referring to FIG. 5, the link between the STA 100 and the AP 200 is set through three steps of scanning, authentication, and association in a broad way. First, the scanning step is a step in which the STA 100 obtains access information of BSS operated by the AP 200. A method for performing the scanning includes a passive scanning method in which the AP 200 obtains information by using a beacon message (S101) which is periodically transmitted and an active scanning method in which the STA 100 transmits a probe request to the AP (S103) and obtains access information by receiving a probe response from the AP (S105).

The STA 100 that successfully receives wireless access information in the scanning step performs the authentication step by transmitting an authentication request (S107a) and receiving an authentication response from the AP 200 (S107b). After the authentication step is performed, the STA 100 performs the association step by transmitting an association request (S109a) and receiving an association response from the AP 200 (S109b). In this specification, an association basically means a wireless association, but the present invention is not limited thereto, and the association may include both the wireless association and a wired association in a broad sense.

Meanwhile, an 802.1X based authentication step (S111) and an IP address obtaining step (S113) through DHCP may be additionally performed. In FIG. 5, the authentication server 300 is a server that processes 802.1X based authentication with the STA 100 and may be present in physical association with the AP 200 or present as a separate server.

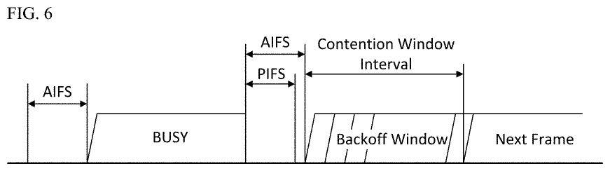

FIG. 6 is a diagram illustrating a carrier sense multiple access (CSMA)/collision avoidance (CA) method used in wireless LAN communication.

A terminal that performs a wireless LAN communication checks whether a channel is busy by performing carrier sensing before transmitting data. When a wireless signal having a predetermined strength or more is sensed, it is determined that the corresponding channel is busy and the terminal delays the access to the corresponding channel. Such a process is referred to as clear channel assessment (CCA) and a level to decide whether the corresponding signal is sensed is referred to as a CCA threshold. When a wireless signal having the CCA threshold or more, which is received by the terminal, indicates the corresponding terminal as a receiver, the terminal processes the received wireless signal. Meanwhile, when a wireless signal is not sensed in the corresponding channel or a wireless signal having a strength smaller than the CCA threshold is sensed, it is determined that the channel is idle.

When it is determined that the channel is idle, each terminal having data to be transmitted performs a backoff procedure after an inter frame space (IFS) time depending on a situation of each terminal, for instance, an arbitration IFS (AIFS), a PCF IFS (PIFS), or the like elapses. According to the embodiment, the AIFS may be used as a component which substitutes for the existing DCF IFS (DIFS). Each terminal stands by while decreasing slot time(s) as long as a random number determined by the corresponding terminal during an interval of an idle state of the channel and a terminal that completely exhausts the slot time(s) attempts to access the corresponding channel. As such, an interval in which each terminal performs the backoff procedure is referred to as a contention window interval.

When a specific terminal successfully accesses the channel, the corresponding terminal may transmit data through the channel. However, when the terminal which attempts the access collides with another terminal, the terminals which collide with each other are assigned with new random numbers, respectively to perform the backoff procedure again. According to an embodiment, a random number newly assigned to each terminal may be decided within a range (2*CW) which is twice larger than a range (a contention window, CW) of a random number which the corresponding terminal is previously assigned. Meanwhile, each terminal attempts the access by performing the backoff procedure again in a next contention window interval and in this case, each terminal performs the backoff procedure from slot time(s) which remained in the previous contention window interval. By such a method, the respective terminals that perform the wireless LAN communication may avoid a mutual collision for a specific channel.

Hereinafter, in the present invention, a terminal may be referred to as a non-AP STA, an AP STA, an STA, a reception device, or a transmission device, and the present is not limited thereto.

<Various PPDU Format Embodiments>

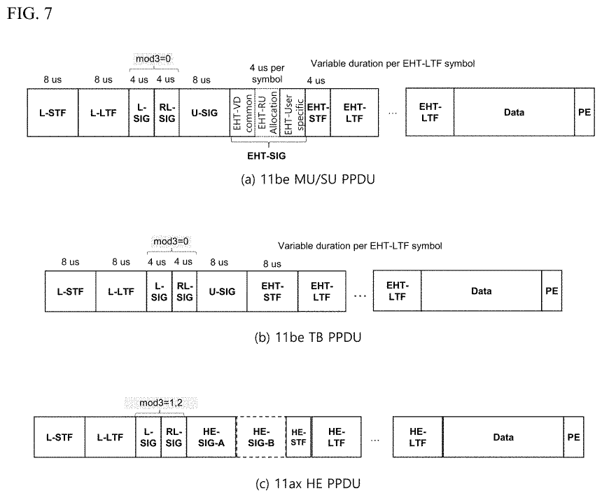

FIG. 7 illustrates a PPDU format of an extremely high throughput (EHT) wireless LAN according to an embodiment of the present invention.

Part (a) of FIG. 7 illustrates an example of a single/multi-user transmission PPDU format, and part (b) of FIG. 7 illustrates an example of a trigger-based (TB) PPDU format. Part (c) of FIG. 7 illustrates an example of a high-efficient (HE) PPDU format in the previous generation, Wi-Fi 802.11ax.

As described in parts (a) to (c) of FIG. 7, a PPDU is divided into a preamble and a data part, and the preamble may commonly include a legacy short training field (L-STF), a legacy long training field (L-LTF), a legacy signal field (L-SIG), and a repeated legacy signal field (RL-SIG) which correspond to legacy fields for backward compatibility.

As described in parts (a) to (c) of FIG. 7, such legacy fields may be included in a preamble of a HE PPDU in 802.11ax corresponding to the previous version as well as an EHT PPDU used in 802.11be.

Referring to parts (a) and (b) of FIG. 7, an 11be TB PPDU and an 11be MU/SU PPDU corresponding to the EHT PPDU may further include a universal signal field (U-SIG) other than the above-described legacy fields, and an SU/MU PPDU may further include, as described in part (a) of FIG. 7, an EHT-SIG field.

The U-SIG corresponds to a field newly introduced in the 11be corresponding to the extremely high throughput communication standard, and a field commonly included in the next-generation 802.11 standard PPDUs including the 11be. The U-SIG field may be continuously included in the EHT PPDU and the next-generation wireless LAN PPDU, and performs a role of distinguishing the generation of the PPDU, including the 11be. The U-SIG field may transfer total 52-bit information as a 64FFT-based OFDM 2 symbol. The interpretation of a partial field of the U-SIG field may vary according to the type of the PPDU, whether multi-user transmission is performed, and OFDMA transmission is performed.

The EHT-SIG field may functionally include an EHT-VD common field, an EHT-resource unit (RU) allocation subfield, and an EHT-user specific field, the interpretation of a partial field of the EHT-SIG field may vary according to the type of the PPDU, whether multi-user transmission is performed, and OFDMA transmission is performed, and the partial field may be omitted.

In this case, the EHT-VD common field and the EHT-RU allocation field may be integrated and referred to as an EHT-common field. The configuration and the modification (compression or omission) form of the EHT-SIG field is described in detail through embodiments below. The EHT-RU allocation field may be referred to as an RU allocation field.

The TB PPDU illustrated in part (b) of FIG. 7 means a PPDU based on a trigger frame, as a trigger-based PPDU. That is, the PPDU illustrated in part (b) of FIG. 7 includes only a U-SIG field after the legacy field in the preamble, as a PPDU transmitted as a response to the trigger frame, and does not include an EHT-SIG field. Accordingly, unlike the MU/SU PPDU in part (a) of FIG. 7, the U-SIG does not include information for decoding the EHT-SIG, and may include puncturing mode information for indicating spatial reuse, whether puncturing is performed, and a pattern of the puncturing, etc.

Referring to parts (a) to (c) of FIG. 7, a terminal may receive a preamble of a PPDU first to perform decoding, and receive data on the basis of the preamble. For example, the terminal may recognize whether the type of the PPDU received through the U-SIG field included in the preamble is the SU/MU PPDU, and may recognize the number of content channels constituting the EHT-SIG field on the basis of the recognized type. Thereafter, the terminal may decode the recognize EHT-SIG field to recognize RUs allocated through the RU allocation subfield, and receive data in the recognized RU.

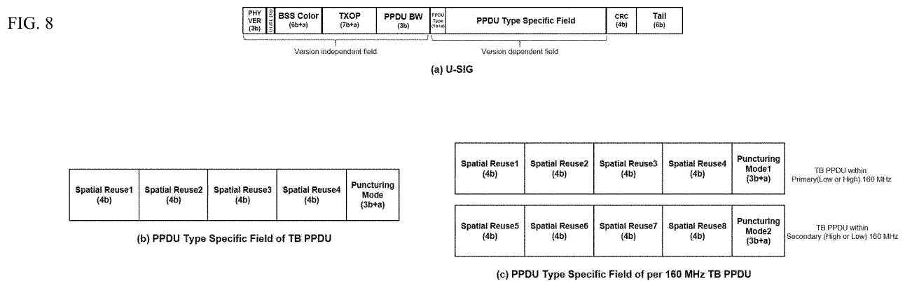

FIG. 8 illustrates a U-SIG field of a TB PPDU according to an embodiment of the present invention.

Referring to FIG. 8, a TB PPDU based on a trigger frame may be divided into a preamble and data, and the preamble may include a U-SIG field commonly included in all PPDUs, and an EHT-SIG field, wherein information indicating inclusion of a field and a field configuration of the EHT-SIG field vary according to the type of the PPDU. In this case, the U-SIG field may include spatial reuse (SR) field for spatial reuse for PPDU transmission and a puncturing mode field for indicating the location of the puncturing and whether the puncturing is performed according to each mode.

The spatial reuse means a method of adjusting and/or configuring an appropriate CCA level according to a situation by an STA, and determining whether a corresponding channel is in an idle state or an occupied state on the basis of the adjusted and/or configured CCA level to transmit a signal, thereby efficiently using a spatial resource. That is, instead of uniformly applying the same CCA level to all channels, the STA may more efficiently use a transmission resource by adjusting the CCA level to a lower level (or reducing a reference to determine whether a channel is in an idle state) when it is determined that a signal transmitted by the STA does not largely influence other STAs with the interference while performing the SR.

Part (a) of FIG. 8 illustrates an example of a configuration of a U-SIG field. As described in part (a) of FIG. 8, the U-SIG field may include version independent fields not influenced by the PHY version, version dependent fields influenced by the PHY version, a CRC field (4 bits), and a tail field (6 bits).

The version independent fields may include PHY VER fields (3 bits) for distinguishing the PHY version, a UL/DL field for indicating an uplink (UL)/downlink (DL) of the corresponding PPDU, a BSS color field, a TXOP field, and a PPDU BW field.

The BSS color field indicates a BSS color index of devices for transmitting or receiving a PPDU, and includes timing information related to a time point at which the PPDU transmission ends. The PPDU BW field may include bandwidth information transmitted by the PPDU. When a partial frequency band is punctured or not allocated within a bandwidth indicated by the PPDU BW field, the corresponding frequency band may not be used for the PPDU transmission. In this case, the PPDU BW may additionally indicate information on the punctured partial bandwidth.

The version independent fields may be commonly included in the MU/SU PPDU as well as the TB PPDU since the version independent fields do not change according to the type of the PPDU, and may be included in a PPDU used in the standard after the 11be.

The version dependent fields may include a PPDU type field (1b+a bits) and a PPDU type specific field. The PPDU type field may indicate the type of the PPDU, and subfields to be included the PPDU type specific field may be changed according to the type of the PPDU.

Part (b) of FIG. 8 illustrates an example of a PPDU type specific field of a TB PPDU. Specifically, the PPDU type specific field of the TB PPDU may include a spatial reuse field for spatial reuse and a puncturing mode field for indicating whether puncturing is performed and/or the location of the puncturing.

In this case, multiple spatial reuse fields may be included according to a bandwidth. For example, as described in part (b) of FIG. 8, four fields including spatial reuse fields 1 to 4 may be included in the PPDU type specific field of the TB PPDU. A value of each of the spatial reuse fields may be encoded to correspond to each frequency area in a bandwidth indicated by the PPDU BW field of the U-SIG

### FIELD

For example, when a PPDU BW indicates 20 MHz, all of the spatial reuse fields 1 to 4 may be encoded to correspond to 20 MHz indicated by the PPDU BW. Alternatively, when the PPDU BW fields indicates a bandwidth as 40 MHz, two spatial reuse fields (for example, spatial reuse fields 1 and 3) may be encoded to correspond to the low 20 MHz of 40 MHz with reference to the center frequency, and the other two spatial reuse fields (for example, spatial reuse fields 2 and 4) may be encoded to correspond to the high 20 MHz of 40 MHz.

Alternatively, when the PPDU BW indicates a bandwidth as 80 MHz, four spatial reuse fields may be encoded to correspond to four 20 MHz bandwidths of 80 MHz, respectively.

When the PPDU BW indicates a bandwidth as 160 MHz, four spatial reuse fields may be encoded to correspond to four 40 MHz bandwidths of 160 MHz, respectively.

When the PPDU BW indicates a bandwidth as 240 MHz, four spatial reuse fields may be encoded to correspond to three 20 MHz bandwidths among 12 20 MHZ bandwidths of 240 MHz, respectively. In this case, three 20 MHz bandwidths corresponding to spatial reuse field 1 (spatial reuse 1) may be three 20 MHZ channels having the lowest frequency components within the 240 MHz bandwidth.

Alternatively, the other three spatial reuse fields may be encoded to correspond to three 80 MHz bandwidths within 240 MHz, respectively, and the remaining one spatial reuse field may be encoded to the same value as that of each of the encoded three spatial reuse fields.

When the PPDU BW indicates a bandwidth as 320 MHz, four spatial reuse fields may be encoded to correspond to four 80 MHz bandwidths of 320 MHz, respectively. In this case, the 80 MHz bandwidth corresponding to spatial reuse field 1 (spatial reuse 1) may have the lowest frequency component among 320 MHz, and the 80 MHz bandwidth corresponding to spatial reuse field 4 may have the highest frequency component.

The puncturing mode field may indicate whether puncturing is performed and/or the location of the puncturing, and may be encoded to the same value as that of the puncturing mode field of the trigger frame.

In this case, a discontinuous format of a PPDU indicated by the puncturing mode field of the trigger frame and an aggregated format (a format of receiving a PPDU) of a TB PPDU transmitted by multiple users via uplink may be different. The reason why the discontinuous format of the PPDU indicated by the puncturing mode and the aggregated format of the TB PPDU varies is that an additional discontinuous format (an unutilized bandwidth format) not indicated by the puncturing mode may be generated since some or all of RUs described as random-access RUs (RA-RUs) are occupied by an STA.

The puncturing mode field of the TB PPDU may be used to cause STAs and an AP of an adjacent BSS to recognize a bandwidth that is not (certainly) utilized among a band included in a UL BW of the TB PPDU.

Part (c) of FIG. 8 illustrates an example of a user specific field of a TB PPDU. Referring to part (c) of FIG. 8, the TB PPDU may include different spatial reuse fields according to the location (bandwidth area) of a transmitted RU, or the type of the TB PPDU. That is, a spatial reuse field included in the TB PPDU may be differentiated according to the transmission location of the TB PPDU and/or the type of the TB PPDU.

Specifically, as shown in part (b) of FIG. 8, when there are only four spatial reuse fields of the TB PPDU for a 320 MHz uplink bandwidth, which includes spatial reuse 1, 2, 3, and 4, each of the spatial reuse fields corresponds to 80 MHz.

However, different spatial reuse fields of the TB PPDU transmitted in the primary and the secondary bandwidths are configured to be differentiated with each 0 other, and thus each of the total eight spatial reuse fields may correspond to the 320 MHz uplink bandwidth. Accordingly, each of the spatial reuse 1 to 8 corresponding to spatial reuse fields included in two types of TB PPDU with reference to a frequency area in which the PPDU is transmitted may correspond to 40 MHz among the UL TB PPDU BW (a BW represented through a combination of TB PPDUs transmitted by respective STAs).

That is, when a non-AP STA transmits a TB PPDU indicated by the trigger frame transmitted from an AP STA, the non-AP STA may differently configure a puncturing mode field and a spatial reuse field included in a PPDU type specific field according to the location of an RU in which the TB PPDU is transmitted and/or the type of the TB PPDU, and may transmit the same.

For example, when the location of the RU in which the TB PPDU is transmitted corresponds to a first type of a TB PPDU corresponding to the primary 160 MHz, the non-AP STA may include spatial reuse 1 to 4 corresponding to spatial reuse fields in the PPDU type specific field of the TB PPDU. However, when the location of the RU in which the TB PPDU is transmitted corresponds to a second type of a TB PPDU corresponding to the secondary 160 MHz, the non-AP STA may include spatial reuse 5 to 8 corresponding to spatial reuse fields in the PPDU type specific field of the TB PPDU.

The first type and the second type may be distinguished according to the PHY version of the TB PPDU, or may be the types of the PPDU according to the Wi-Fi standard. For example, the first type may be a HE TB PPDU, and the second type may be an EHT-TB PPDU.

The non-AP STA may configure spatial reuse 1 to 8 on the basis of information included in the trigger frame, and information for configuring the spatial reuse field may be included in different fields of the trigger frame according to the location of the RU in which the TB PPDU is transmitted and/or the type of the TB PPDU.

As shown in part (b) of FIG. 8, when a single spatial reuse field corresponds to 80 MHz and spatial reuse of another BSS is restricted due to a partial 20 MHz bandwidth of the 80 MHz bandwidth, whether the remaining reusable 60 MHz bandwidth is to be also restricted may be a problem. Accordingly, to increase the efficiency of the spatial reuse, the size of a bandwidth correspond to the single spatial reuse field may be reduced, and to this end, the number of spatial reuse fields corresponding to respective bandwidths may be increased.

However, in a case multiple spatial reuse fields are configured and transmitted, signaling overhead increases due to an increase in the size of a U-SIG field, and thus when different spatial reuse fields are configured between TB PPDUs transmitted in the primary 160 MHz bandwidth and the secondary 160 MHz bandwidth, as shown in part (c) of FIG. 8, many more spatial reuse fields may be configured and transmitted without the increase in the signaling overhead.

According to an embodiment of the present invention, after a trigger frame indicating a 320 MHz uplink bandwidth is received, a transmitted TB PPDU of a single STA may be transmitted by using only RU(s) of either the primary 160 MHz bandwidth or the secondary 160 MHz bandwidth.

According to another embodiment of the present invention, after a trigger frame indicating a 240 MHz uplink bandwidth is received, a transmitted TB PPDU of a single STA may be transmitted by using only RU(s) of either the low 160 MHz bandwidth or the high 160 MHz bandwidth.

Referring to part (c) of FIG. 8, the TB PPDU transmitted through the RU within the primary 160 MHz bandwidth may include four spatial reuse fields in a PPDU type specific field, and four spatial reuse fields may correspond to four 40 MHz RUs in the primary 160 MHz bandwidth, respectively.

In addition, the TB PPDU transmitted through the RU within the second 160 MHz bandwidth may include four spatial reuse fields in a PPDU type specific field, and four spatial reuse fields may correspond to four 40 MHz RUs in the secondary 160 MHz bandwidth, respectively.

When the bandwidth indicated through a PPDU BW is 240 MHz, the primary BW and the secondary BW may have an 80 MHz bandwidth. In this case, the spatial reuse fields (for example, four spatial reuse fields) of a TB PPDU transmitted through the primary 80 MHz and/or secondary 80 MHz RU may correspond subchannels (20 MHz) within the 80 MHz bandwidth, respectively.

In the present embodiment, the PPDU type specific field may additionally include a puncturing mode field indicating a puncturing mode as well as the spatial reuse field. Similar to the spatial reuse fields, different puncturing mode fields may be included according to whether the location of an RU through which an STA having received a trigger frame transmits a TB PPDU is either a primary BW or a secondary BW. That is, each of the puncturing mode field 1 and puncturing mode field 2, which are differently configured according to a bandwidth (or segment) in which the RU for transmission of the TB PPDU is located, may be included in the TB PPDU.

For example, as described in part (c) of FIG. 8, puncturing mode field 1 may be included in the TB PPDU transmitted in the primary 160 MHz bandwidth, and indicate a discontinuous channel format in the primary 160 MHz bandwidth, and puncturing mode field 2 may be included in the TB PPDU transmitted in the secondary 160 MHz bandwidth, and indicate a discontinuous channel format in the second 160 MHz bandwidth.

When fields indicating the puncturing mode are individually configured according to a bandwidth and transmitted as shown in part (c) of FIG. 8, a discontinuous channel format for the entire uplink bandwidth can be signaled with higher resolution than that in the method of signaling a discontinuous channel through a single puncturing mode field shown in FIG. 8B.

<Trigger Frame Format>

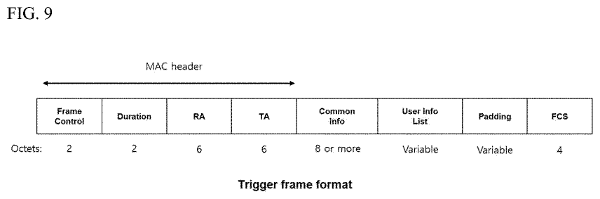

FIG. 9 illustrates an example of a trigger format according to an embodiment of the present invention.

Referring to FIG. 9, a trigger frame may include a frame control field, a duration field, a resource allocation (RA) field, a timing advanced field, a common information field, a user information list field, and a padding and FCS field. The trigger frame may not include some of the above-mentioned fields, or some additional fields may be further included.

The frame control field, the duration field, the RA field, and the TA field may be identical to fields included in the general MAC header in the 802.11 standard.

The common information field may include information on several parameters used when devices to which a resource unit is allocated through a trigger frame transmit a TB PPDU as a response thereto.

The user information list may include at least one user information field including individual information of each STA. The padding field may be included to secure a time for generating and preparing the TB PPDU. When a user information field of a reception device is located at the back of the user information list, a time for the reception device to recognize an RU allocated to the reception device itself and generate and transmit the TB PPDU may be insufficient. Accordingly, the padding field may be additionally located after the user information list field of the trigger frame so that each reception device can secure a sufficient time to recognize the RU and prepare the TB PPDU.

Reception devices each having received the trigger frame may transmit a TB PPDU through an RU allocated by a trigger frame as a response to a transmitted trigger frame when the received trigger frame corresponds to a trigger frame transmitted to each of the reception devices. When trigger frames are transmitted to multiple reception devices, the multiple reception devices having received the trigger frames may simultaneously transmit TB PPDUs, and the TB PPDUs may be aggregated in an aggregated (A)-PPDU format and transmitted. In addition, when PPDUs are transmitted and received as the A-PPDU form from multiple STAs, as a response to the trigger frame, the formats of the aggregated TB PPDUs may be different from each other. For example, a HE TB PPDU and an EHT TB PPDU may be aggregated, or different types (or formats) of TB PPDUs may be aggregated and transmitted.

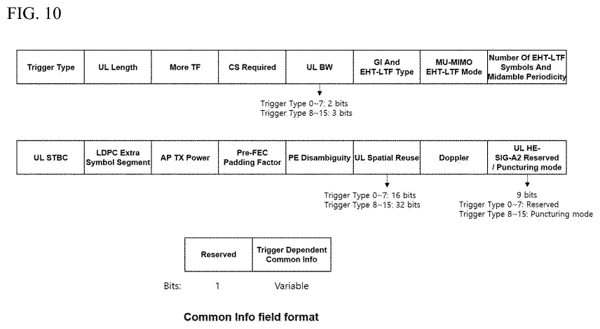

FIG. 10 illustrates an example of a configuration of a common information field of a trigger frame according to an embodiment of the present invention.

The common information field may include a parameter/information commonly applied to all terminals receiving a trigger frame. As shown in FIG. 10, a trigger type field may indicate a trigger type of a trigger frame and include four bits.

Table 1 below shows an example of trigger frame types according to a value of a trigger type field.

TABLE 1

| Trigger Type | |
|---|---|
| subfield value | Trigger Frame Variant |
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | EHT-Basic |
| 9 | EHT-Beamforming Report Poll (BFRP) |
| 10 | EHT-MU-BAR |
| 11 | EHT-MU-RTS |
| 12 | EHT-Buffer Status Report Poll (BSRP) |
| 13 | EHT-GCR MU-BAR |
| 14 | EHT-Bandwidth Query Report Poll (BQRP) |
| 15 | EHT-NDP Feedback Report Poll (NFRP) |

Referring to table 1, four bits of the trigger type field may be encoded to “0000” to “1111” and indicate trigger types of the trigger frame, respectively. For example, four bits of the trigger type field may indicate, according to an encoded value, Basic (0), Beamforming Report Poll (1), MU-BAR (2), MU-RTS (3), Buffer Status Report Poll (4), GCR MU-BAR (5), Bandwidth Query Report Poll (6), NDP Feedback Report Poll (7), EHT-Basic (8), EHT-Beamforming Report Poll (9), EHT-MU-BAR (10), MU-RTS (11), EHT-Buffer Status Report Poll (12), EHT-GCR MU-BAR (13), EHT-Bandwidth Query Report Poll (14), and EHT-NDP Feedback Report Poll (15) types of trigger frames.

Bit values from “0” to “7” by the trigger type field may indicate the same trigger frame type as a trigger type field of the HE (802.11ax). Accordingly, when a value of a trigger frame type field corresponding to the HE-based HE trigger frame is “0” to “7”, the same trigger frame as that in the 802.11ax may be configured, and thus a common information field, a trigger dependent common information field, and user fields may be configured and encoded in the same formats.

However, the type of the trigger frame in which the bit values by the trigger type field are from “8” to “15” may be indicated only when the PHY version of the trigger frame is EHT (11be). That is, only when the trigger frame is an EHT-based EHT trigger frame, the bit value by the trigger type field may be configured as one of values from “8” to “15”. The EHT-based EHT trigger frame having the values of the trigger type field from “8” to “15” may perform the same function as the corresponding trigger frames from “0” to “7”.

When the value of the trigger type field is one of “8” to “15”, the trigger frame corresponds to the EHT-based EHT trigger frame, and thus fields (for example, additional information fields) other than the HE-based HE trigger field having values of the trigger type field from “0” to “7” may be included. For example, the trigger frame having values of the trigger type from “8” to “15 may further include an additional bandwidth field, a puncturing mode field, and/or an additional UL spatial reuse field for additional spatial reuse. Such additional information fields may be used to apply a function (for example, 240/320 MHz operation, multi-RU allocation, etc.) newly added to the EHT to the trigger frame-based operation.

For the additional information fields, a field functionally identical to fields included in the trigger frame having the trigger type field values from “0” to “7” may be extended, or the additional information fields may be added by using a reserved field.

As shown in FIG. 10, the size of a UL BW field may vary according to a 5 value of a trigger type field. For example, when the value of the trigger type value is one of “0” to “7”, the size of the UL BW field may be 2 bits. However, when the value of the trigger type field is one of “8” to “15”, the size of the UL BW field may be 3 bits, and six BW modes (20 MHz, 40 MHz, 80 MHz, 160 (80+80) MHz, 240 (160+80) MHz, and 320 (160+160) MHz) may be indicated.

The size of the UL spatial reuse field may vary according to a value of a trigger type field. For example, when the value of the trigger type field is one of “0” to “7”, the size of the UL spatial reuse field may be 16 bits. However, when the value of the trigger type value is one of “8” to 15″, the UL spatial reuse field may include eight spatial reuse fields, each bit size of which is 4 bits, and may be a total of 32 bits.

There is a total of eight spatial reuse fields because the spatial reuse operation cannot be efficiently operated since a BW corresponding to each spatial reuse field is maximum 80 MHz when only the conventional four spatial reuse fields are utilized for the 240 MHz or 320 MHz PPDU. Accordingly, when the number of spatial reuse fields is increased to eight, the BW corresponds to only maximum 40 MHz, and thus the spatial reuse operation can be more efficiently performed.

When the trigger type is one of 8 to 15, the UL HE-SIG-A2 reserved field may be utilized as a puncturing mode field.

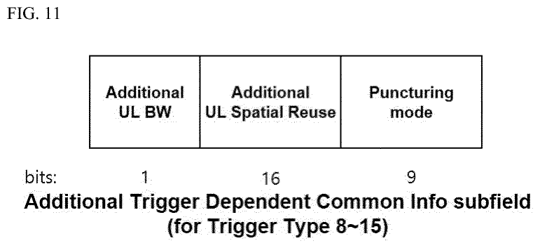

FIG. 11 illustrates an example of a configuration of an additional information field according to a format of a trigger frame according to an embodiment of the present invention.

Referring to FIG. 11, an additional information field may be included according to whether a trigger frame is based on the HE or the EHT, and the additional information field may further include additional information for an EHT trigger frame-based TB PPDU response.

Specifically, a value of a trigger type field included in a trigger frame is configured as a value of one of “8” to “15” and the trigger frame is the EHT trigger frame, the trigger frame may further include an additional trigger dependent common info subfield shown in FIG. 11.

As described above, the additional information field may include an additional bandwidth field, a puncturing mode field, and/or a UL spatial reuse field for additional spatial reuse. In this case, in a common information field except for the additional information field, a trigger frame in which values of the trigger type field are “0” to “7” and a trigger frame in which values of the trigger type field are “8” to “15” have the same bit and field configurations.

The additional information field illustrated in FIG. 11 may be commonly included in the EHT-based trigger frame in which values of the trigger type field are “8” to “15”, and when the value of the trigger type field is “13”, the additional information field may be included together with (EHT-GCR MU-BAR) BAR Control (2 Octets) and BAR Information (2 Octets).

When a PPDU is transmitted as a response to the EHT-based trigger frame, the additional information field includes additional information for generating the EHT TB PPDU. The additional information field may be located immediately after the common information field, and may have 1 bit or 2 bits.

In addition, a specific field located immediately before the additional information field may indicate whether the additional information field is included after the common information field. That is, when the value of the specific field is configured as a specific value (“1” or “0”), a non-AP STA may recognize that the additional information field is included after the common information field. In this case, the trigger frame may be recognized as an EHT trigger frame, and the non-AP STA may respond through an EHT TB PPDU. If the specific field indicates that the additional information field is not included, the trigger frame may be recognized as a HE trigger frame, and the non-AP STA may respond through a HE TB PPDU. In this case, the specific field may have a 1-bit size, and may be “B63”, “B53”, or another bit.

The non-AP STA may identify, through an identifier of the additional information field other than the specific field, whether the additional field is included after the common information field. For example, when a value of an identifier (for example, an association identifier (AID)) of the additional information field is configured as a specific value (for example, AID=2007), it may indicate that the additional information field is included after the common information field.

When a received trigger frame is the HE trigger frame, the non-AP STA may respond through the HE TB PPDU, and may respond through the HE TB PPDU or the EHT TB PPDU on the basis of the received trigger frame. In this case, when an RU allocated for transmission of a response frame to the trigger frame is located at a bandwidth at which a primary channel is not located, the non-AP STA may transmit only the EHT TB PPDU as a response to the trigger frame. That is, when the allocated RU is located at a primary BW, the non-AP STA may respond through the HE TB PPDU or the EHT TB PPDU according to the type and configuration of the trigger frame. However, when the allocated RU is located at a secondary BW, the non-AP STA may respond through the EHT TB PPDU only.

For example, the non-AP STA may respond through the TB PPDU or the EHT TB PPDU on the basis of a format (for example, a case where a format of a user information field included in the trigger frame is a HE format or an EHT format) related to the trigger frame. Specifically, the non-AP STA may respond through the HE TB PPDU after receiving the trigger frame when the format of the user information field included in the trigger frame is the HE format. However, when the format of the user information field included in the trigger frame is the EHT format, the non-AP STA may respond through the EHT TB PPDU.

The additional information field may be referred to as a special user information field, and fields included in the additional information field may be interpreted together with fields included in the common information.

1 bit or 2 bits may be allocated to the additional UL BW field, and the additional UL BW field may be aggregated with a bandwidth field included in the common information field and interpreted. That is, when the additional UL bandwidth field is included in the additional information field, the non-AP STA may recognize a bandwidth for transmission of the TB PPDU in consideration of the additional UL bandwidth field in addition to the bandwidth field of the common information field. In this case, six of eight (or 16) BW modes which can be indicated by 2 bits of the bandwidth field and 1 bit (or 2 bits) of the additional UL BW field may correspond to 20 MHz, 40 MHz, 80 MHz, 160 (80+80) MHz, 240 (160+80) MHz, and 320(160+160) MHz.

The additional UL spatial reuse field may signal a value for a spatial reuse operation for a frequency area not indicated by the UL spatial reuse field of the common field. The UL spatial reuse field of the common information field may include four spatial reuse fields, and the additional UL spatial reuse field may include another four spatial reuse fields, so that a total of eight spatial reuse fields may be indicated for the entire bandwidth. That is, multiple spatial reuse fields included in the common information field and the additional UL spatial reuse fields included in the additional information field may indicate frequency bands for spatial reuse operations for different bandwidths, respectively.

For example, when each of the spatial reuse fields included in the common information field indicates a frequency band for a spatial reuse operation for a primary BW, the additional spatial reuse fields included in the additional information field may indicate a frequency band for a spatial reuse operation for a secondary BW.

Accordingly, when the non-AP STA transmits a TB PPDU in the primary BW (or when the TB PPDU is the HE TB PPDU), the non-AP STA may generate the TB PPDU by using spatial reuse fields included in the common information of the trigger frame. However, when the non-AP STA transmits a TB PPDU in the secondary BW (or when the TB PPDU is the EHT TB PPDU), the non-AP STA may generate the TB PPDU by using one or more spatial reuse fields included in the additional information field of the trigger frame.

That is, when the non-AP STA transmits a TB PPDU as a response to the trigger frame, the non-AP STA may generate the TB PPDU by using one or more spatial reuse fields included in different fields according to whether the TB PPDU to be responded corresponds to the HE TB PPDU or the EHT TB PPDU.

The puncturing mode field may signal a discontinuous format of the PPDU through the trigger frame is transmitted. The trigger frame may be transmitted by using a discontinuous channel except for some channels among the operating BW, and the discontinuous channel format of the RU through the trigger frame is transmitted may be indicated by the puncturing mode field.

In addition, the same mode as the puncturing mode field of the SU PPDU may be applied to the puncturing mode field of the trigger frame, and the puncturing mode field of the trigger frame may be encoded. In addition, in order to signal the discontinuous channel format of the entire PPDU BW, instead of the puncturing mode field, a bitmap (8-bit or 16-bit bitmap) indicating whether each 20 MHz channel is used may be included.

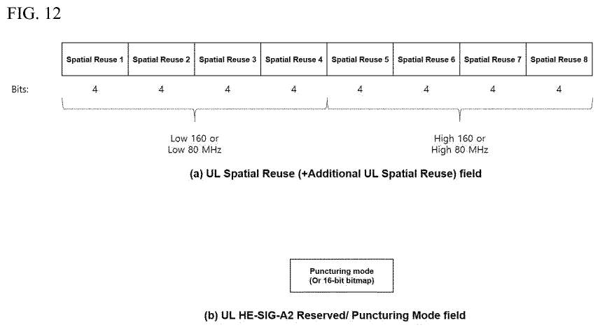

FIG. 12 illustrates an example of a spatial reuse field and a puncturing mode field for uplink transmission according to an embodiment of the present invention.

Part (a) of FIG. 12 illustrates an embodiment of a UL spatial reuse field for an uplink spatial reuse operation, and includes a total of eight spatial reuse fields. Four of eight spatial reuse fields indicated by the trigger frame for a 320 (or 160+160) MHz bandwidth may indicate a spatial reuse value corresponding to low 160 or 80 MHz, and the remaining four spatial reuse fields may indicate a spatial reuse value corresponding to high 160 or 80 MHz.

In this case, multiple spatial reuse fields shown in part (a) of FIG. 12 may be divided and included in a UL spatial reuse field included in a common field and an additional UL spatial reuse field included in an additional information field. That is, some of the multiple spatial reuse fields may be included in the UL spatial reuse field 5 included in the common field, and the remaining spatial reuse fields may be included in the additional UL spatial reuse field included in the additional information field.

Each spatial reuse field may include four bits, and may indicate a spatial reuse value applied to a maximum 40 MHz bandwidth.

For example, when a total bandwidth is 320 MHz, four spatial reuse fields 0 corresponding to primary 160 MHz may correspond to low 40 MHz of low 80 MHz, high 40 MHz of low 80 MHz, low 40 MHz of high 80 MHz, and high 40 MHz of high 80 MHz, respectively. Similarly, four spatial reuse fields corresponding to high 160 MHz may correspond to lowest 40, low 40 MHz, high 40 MHz, and highest 40 MHz of high 160 MHz, respectively.

When the total bandwidth is 240 (or 160+80 or 80+160) MHz, four of eight spatial reuse fields included in the trigger frame may correspond to low 160 MHz or low 160 80 MHz, and the remaining four spatial reuse fields may correspond to high 80 MHz or high 160 MHz. In this case, the terms “low” and “high” are used only to divide a frequency area into 160 MHz+80 MHz, and may not be related to the locational relations between actual frequencies. In this case, four spatial reuse fields corresponding to 80 MHz may be configured as spatial reuse values each indicting 20 MHz.

When the total bandwidth is 160 (or 80+80) MHz, four of eight spatial reuse fields included in the trigger frame may correspond to bandwidths of 40 MHz (lowest 40 MHz, low 40 MHz, high 40 MHz, and highest 40 MHz), respectively, and the remaining four may be encoded to the same value as spatial reuse field values, each corresponding to 40 MHz.

In addition, when the trigger frame indicates an 80 MHz bandwidth, four of eight spatial reuse fields may correspond to bandwidths of 20 MHz (lowest 20 MHz, low 20 MHz, high 20 MHz, and highest 20 MHz), respectively, and the remaining four may be encoded to the same value as spatial reuse field values, each corresponding to 20 MHz.

In addition, when the trigger frame indicates a 40 MHz bandwidth, four of eight spatial reuse fields may correspond to bandwidths of 20 MHz (low 20 MHz and high 20 MHz), respectively, and the remaining six may be encoded to the same value as spatial reuse field values, each corresponding to 20 MHz.

In addition, when the trigger frame indicates a 20 MHz bandwidth, all eight spatial reuse fields may indicate a spatial reuse value corresponding to the primary 20 MHz.

As another embodiment of the present invention, a UL spatial reuse field may include four spatial reuse fields. In this case, each of the four spatial reuse fields may indicate an 80 MHz spatial reuse value for the 320 MHz bandwidth, and may indicate a 40 MHz spatial reuse value of the 160 MHz bandwidth. In addition, for the 80 MHz bandwidth, each of the fields may indicate a 20 MHz spatial reuse value.

When the 40 MHz bandwidth is indicated by the trigger frame, two spatial reuse fields may correspond to low 20 MHz and high 20 MHz, respectively, and the remaining two may be encoded to the same value as spatial reuse field values each corresponding to 20 MHz. In addition, when the 20 MHz bandwidth is indicated by the trigger frame, all four spatial reuse fields may indicate a spatial reuse value corresponding to the primary 20 MHz.

Part (b) of FIG. 12 illustrates an example of a puncturing mode field (8 bit or 16 bits). The puncturing mode field indicates a discontinuous channel format of a PPDU through which the trigger frame is transmitted. That is, the puncturing mode for the bandwidth in which the PPDU corresponding to the trigger frame is transmitted may be indicated by the puncturing mode field. Here, the puncturing mode may indicate whether a part of the entire bandwidth is punctured and the location of the puncturing.

The puncturing mode field (or a 16-bit bitmap) may be included in an additional information field other than a (UL HE-SIG-A2) reserved field of a common information field, and may include two puncturing mode subfields. When two puncturing mode subfields are included, the discontinuous format of the channel through which the trigger frame included in the 320 MHz or 240 MHz PPDU may be divided into 160 MHz bandwidth intervals, and whether puncturing is performed and the location of the puncturing may be indicated by the puncturing mode subfield.

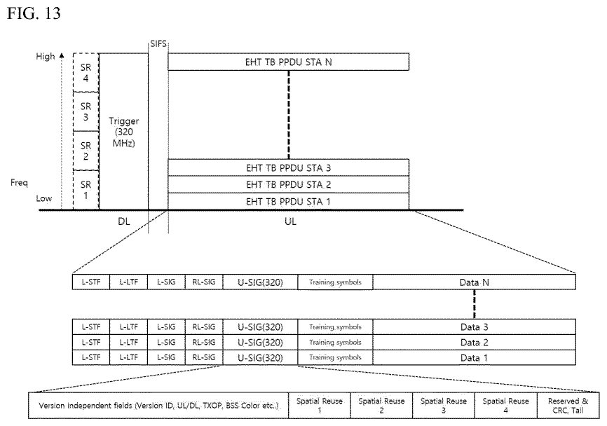

FIG. 13 illustrates an example of transmission of a trigger frame and a trigger frame-based TB PPDU according to an embodiment of the present invention.

Referring to FIG. 13, when multiple spatial reuse fields are included in a trigger frame and transmitted, each STA may transmit a response frame as a response to the trigger frame on the basis of the multiple spatial reuse fields.

Specifically, STA1 to STA N having received trigger frames from an AP STA may identify a UL spatial reuse field included in a common information field of the trigger frame, and generate a TB PPDU by encoding values of four spatial reuse fields included in the UL spatial reuse field to respective spatial reuse fields 1 to 4 included in a U-SIG field of a TB PPDU.

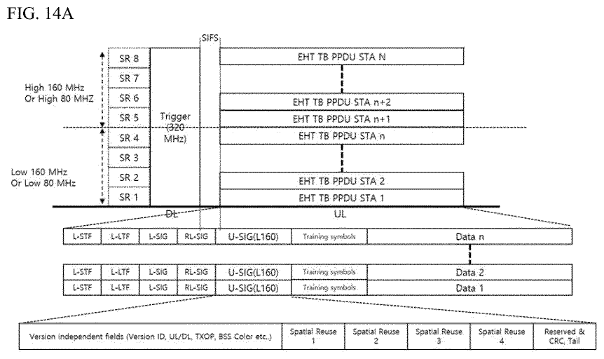

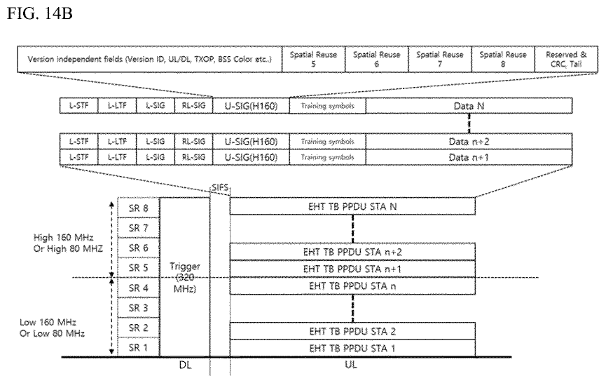

FIGS. 14A and 14B illustrate another example of transmission of a trigger frame and a trigger frame-based TB PPDU according to an embodiment of the present invention.

Referring to FIGS. 14A and 14B, when multiple spatial reuse fields are indicated through a trigger frame, TB PPDUs may be generated and transmitted or received through different spatial reuse fields.

Specifically, multiple spatial reuse fields may be transmitted through the trigger frame. In this case, some of the multiple spatial reuse frames may be included in a common information field, and the remaining spatial reuse fields may be included in an additional information field.

In this case, a non-AP STA may generate a response frame by using spatial reuse fields included in the common information field or the additional information field according to whether the location of an RU allocated to the non-AP STA or whether a response frame to the trigger frame is either a HE TB PPDU or an EHT TB PDDU.

For example, when the location of the RU allocated to the non-AP STA is included in a secondary BW or a format related to the trigger frame is an EHT format (for example, when a format of a user information field is the EHT format), the non-AP STA may generate an EHT TB PPDU by using spatial reuse fields included in the additional information field, and transmit the generated EHT TB PPDU as the response frame of the trigger frame. However, when the location of the RU allocated to the non-AP STA is included in a primary BW or a format related to the trigger frame is a HE format (for example, when a format of a user information field is the HE format), the non-AP STA may generate a HE TB PPDU by using spatial reuse fields included in the common information field and transmit the generated HE TB PPDU as a response frame to the trigger frame.

For example, as illustrated in FIG. 14A, among STA 1 to STA N corresponding to non-AP STAs having received a trigger frame, STA 1 to STA n each having an RU allocated by the trigger frame and located in low 160 MHz or low 80 MHz with reference to the center frequency select spatial reuse fields 1 to 4 corresponding to low 160 MHz or low 80 MHz from among eight spatial reuse fields 1 to 8 included in the trigger frame. STA 1 to STA n may encode the selected spatial reuse fields 1 to 4 to spatial reuse fields 1 to 4 included in a U-SIG field of a TB PPDU corresponding to a response frame to the trigger frame, respectively.

In this case, when the TB PPDU generated by STA 1 to STA n is the HE TB PPDU, spatial reuse fields 1 to 4 may be spatial reuse fields included in the common information field of the trigger frame, and when the TB PPDU generated by STA 1 to STA n is the EHT TB PPDU, spatial reuse fields 1 to 4 may be spatial reuse fields included in the additional information field of the trigger frame.

As illustrated in FIG. 14B, among STA 1 to STA N corresponding to non-AP STAs having received a trigger frame, STA n+1 to STA N having an RU allocated by the trigger frame and located in high 160 MHz or high 80 MHz with reference to the center frequency select spatial reuse fields 5 to 8 corresponding to high 160 MHz or high 80 MHz from among eight spatial reuse fields 1 to 8 included in the trigger frame. STA n+1 to STA N may encode the selected spatial reuse fields 5 to 8 to 5 spatial reuse fields 1 to 4 included in a U-SIG field of a TB PPDU corresponding to a response frame to the trigger frame, respectively.

In this case, when the TB PPDU generated by STA n+1 to STA N is the HE TB PPDU, spatial reuse fields 5 to 8 may be spatial reuse fields included in the common information field, and when the TB PPDU generated by STA 1 to STA n is the EHT TB PPDU, spatial reuse fields 5 to 8 may be spatial reuse fields included in the additional information field.

In FIGS. 14A and 14B, the trigger frame may indicate transmission of the HE TB PPDU and/or the EHT TB PPDU. In this case, at least one non-AP STA having received the trigger frame may transmit the HE TB PPDU or the EHT TB PPDU as a response to the trigger frame. Whether the at least one non-AP STA transmits either the HE TB PPDU or the EHT TB PPDU may be based on the location of the allocated RU and/or the format related to the trigger frame.

For example, when the location of the RU allocated by the trigger frame is a secondary BW not including a primary channel or the format related to the trigger frame is an EHT format (for example, when a format of a user information field is the EHT format), an EHT TB PPDU may be generated and transmitted as a response to the trigger frame. However, when the location of the RU allocated by the trigger frame is a primary BW including a primary channel or the format related to the trigger frame is a HE format (for example, when a format of a user information field is the HE format), a HE TB PPDU may be generated and transmitted as a response to the trigger frame.

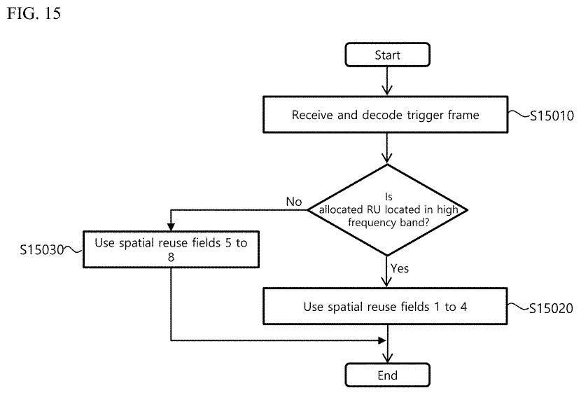

FIG. 15 is a flowchart illustrating an example of a method for selecting a spatial reuse field for generation of a TB PPDU on the basis of a trigger frame according to an embodiment of the present invention.

Referring to FIG. 15, an STA having received a trigger frame may decode a preamble of the trigger frame to recognize an RU for uplink transmission, and generate a TB PPDU by using spatial reuse fields of different trigger frames according to the recognized location of the RU.

Specifically, an AP STA may transmit a trigger frame indicating TB PPDU transmission, and a non-AP STA may receive the trigger frame from the AP STA and decode the received trigger frame (S15010).

Thereafter, the non-AP STA may generate a TB PPDU as a response to the received trigger frame to transmit the TB PPDU indicated by the trigger frame. In this case, the non-AP STA may use information included in the trigger frame to generate the TB PPDU.

Specifically, the non-AP STA may decode the trigger frame to recognize an RU allocated for transmission of the TB PPDU of the non-AP STA through an RU allocation information field of the trigger frame. The non-AP STA may determine whether the location of the RU allocated for the TB PPDU transmission is a high frequency band (or a primary BW including a primary channel) or a low frequency band (or a secondary BW not including the primary channel) with reference to the center frequency of the entire bandwidth. When the location of the allocated RU is the high frequency band (or primary BW), the non-AP STA may generate the TB PPDU by encoding spatial reuse fields 1 to 4 included in the trigger frame to spatial reuse fields 1 to 4 of the TB PPDU (S15020).

In this case, when the generated TB PPDU is a HE TB PPDU, spatial reuse fields 1 to 4 of the trigger frame, which are used for the generation of the TB PPDU, may be spatial reuse fields included in the common information field of the trigger frame.

However, when the location of the allocated RU is the low frequency band (or secondary BW), the non-AP STA may generate a TB PPDU by encoding spatial reuse fields 5 to 8 included in the trigger frame to spatial reuse fields 1 to 4 of the TB PPDU (S15030).

In this case, when the generated TB PPDU is an EHT TB PPDU, spatial reuse fields 5 to 8 of the trigger frame, which are used for the generation of the TB PPDU, may be spatial reuse fields included in the additional information field of the trigger frame.

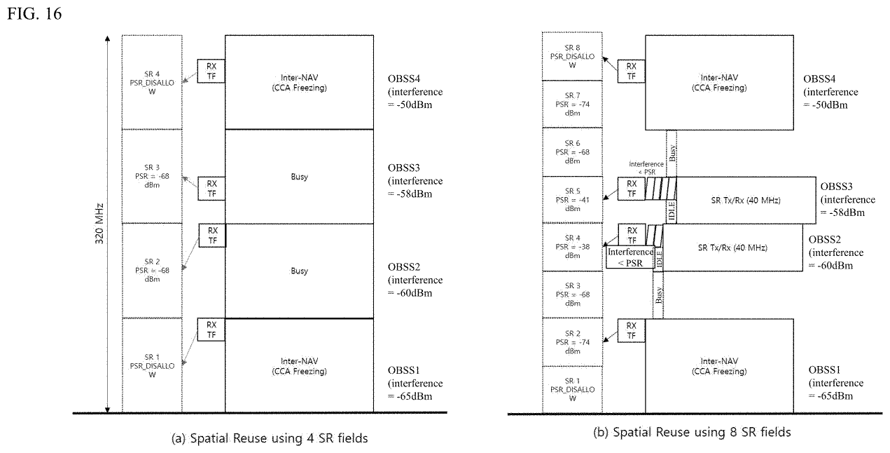

FIG. 16 illustrates an example of a spatial reuse operation according to the number of spatial reuse fields for a frequency band according to an embodiment of the present invention.

Referring to FIG. 16, an area of a bandwidth corresponding to a spatial reuse field and a spatial reuse result of an OBSS may vary according to the number of spatial reuse fields for a bandwidth for PPDU transmission.

Specifically, as illustrated in FIG. 16, there are four OBSS 1 to 4 each having a primary channel in a 320 MHz bandwidth in which a 320 MHz TB PPDU is transmitted, and four OBSS 1 to 4 may encounter interference of −65 dBm, −60 dBm, −58 dBm, and −50 dBm, respectively, by the TB PPDU.

In this case, when only four spatial reuse fields are used, as shown in part (a) of FIG. 16, each of the four spatial reuse fields may be configured as a spatial reuse restriction-related value allowed in 80 MHz. However, when eight spatial reuse fields are used, as shown in part (b) of FIG. 16, each of the eight spatial reuse fields may be configured as a spatial reuse restriction-related value allowed in 40 MHz. In this case, the value configured in the spatial reuse field may be the strictest value of a spatial reuse condition applied to a BW corresponding to the spatial reuse field. Accordingly, one spatial reuse field corresponding to 80 MHz may be configured as a lower value (a value used to more restrict spatial reuse) between two spatial reuse fields corresponding to two 40 MHz bandwidths in 80 MHz, respectively.

As shown in part (a) of FIG. 16 in which four spatial reuse values are used for the 320 MHz bandwidth through the TB PPDU, a spatial reuse value of a bandwidth in which a primary channel of each of the STAs exists in OBSS 1 to 4 may be PSR_DISALLOW, −68 dBm, −68 dBm, and PSR_DISALLOW. In this case, an STA identifies that a spatial reuse operation is not allowed in OBSS1 and OBSS4, and does not attempt to perform channel access. In addition, OBSS2 and OBSS3 may identify that spatial reuse is allowed in a band where a primary channel of each of the OB and OBSS3 exists, but the interference in OBSS2 and OB is greater than a spatial reuse threshold, and thus a backoff procedure for channel access cannot be performed.

However, as shown in part (b) of FIG. 16 in which eight spatial reuse values are used for the 320 MHz bandwidth through the TB PPDU, a spatial reuse value of a bandwidth in which a primary channel of each of the STAs exists in OBSS 1 to 4 may be −72 dBm, −38 dBm, −41 dBm, and PSR_DISALLOW. In this case, OBSS2 and OBSS3 may identify that spatial reuse is allowed in a band where a primary channel of each of the OB and OB exists, the interference in OB and OB (or from the TB PPDU) is less than a spatial reuse threshold, and thus transmission can be performed after a backoff procedure for channel access is performed.

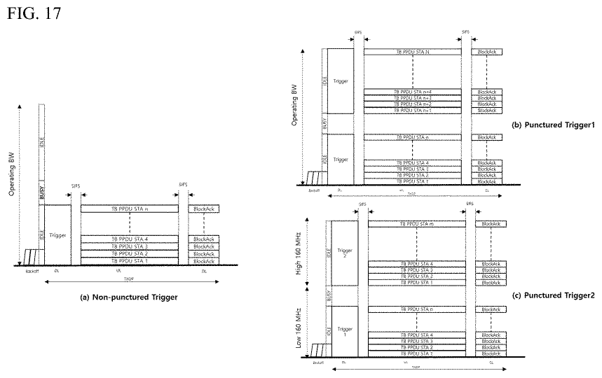

FIG. 17 illustrates an example of a method for transmitting a trigger frame according to an embodiment of the present invention.

Referring to parts (a) to (c) of FIG. 17, a format in which a trigger frame is transmitted may vary according a format a transmitted resource and the number of transmitted resources.

Specifically, since a trigger frame in 11be is a MAC frame, transmission may be performed over 20 MHz, 40 MHz, 80 MHz, 160 MHz, and 320 MHz according to a BW of a PPDU through which the trigger frame is transmitted.

As illustrated in part (a) of FIG. 17, when some of operating BWs of an AP are occupied by heterogeneous devices or OBSS (when a CCA results shows “BUSY”), the BW of the PPDU through which the trigger frame is transmitted is limited, and the trigger frame can be transmitted only through some of the operating BWs. This is a problem caused when a wide bandwidth channel access scheme follows a channel bonding scheme, and the SU PPDU puncturing operation introduced to 11be is utilized so that the trigger frame can be transmitted in a much wider BW by using a channel except for the channel determined as “BUSY”.

As illustrated in part (b) of FIG. 17, the trigger frame may be transmitted only through a frequency band remaining after excluding the channel determined as “BUSY” a result of the CCA, in the operating BW. In this case, a discontinuous format of a PPDU through which the trigger frame is transmitted may be signaled by the EHT PHY indicated before the MAC frame including the trigger frame. In this case, the discontinuous format of the PPDU through which the trigger frame is transmitted may be dependent on and limited to the discontinuous format of the SU PPDU allowed in the EHT. In addition, the trigger frame may be repeatedly shown in each 20 MHz PPDU, and may be transmitted in the discontinuous format wherein the trigger frame is not shown only in a specific channel (a channel determined as “BUSU” as a result of CCA). In this case, the transmission format of the trigger frame may be similar to the U-SIG transmission scheme shown in the punctured PPDU.

As illustrated in part (c) of FIG. 17, two trigger frames may be simultaneously transmitted. This is because an operating BW of an STA transmitting a TB PPDU through a trigger frame can be included only some of BWs of a trigger frame transmitted by an AP. For example, an operating BW of an STA transmitting a UL MU TB PPDU through a 320 MHz trigger frame may be limited to exist only within low 160 MHz or high 160 MHz.

In this case, two trigger frames may be transmitted in two areas obtained by dividing a PPDU BW. The PPDU BW may be divided into two areas on the basis of whether a BW of one area is 160 MHz. That is, the PPDU BW may be divided so that a BW of one PPDU can be 160 MHz.

In addition, trigger frames shown in two areas may be shown in the discontinuous format within the respective area. In this case, the discontinuous format applied to and shown in each of the two trigger frames may be dependent on and limited to an SU PPDU discontinuous format allowed in the BWs including the two trigger frames. For example, in part (c) of FIG. 17, a discontinuous format allowed in Trigger 1 may be limited only to a discontinuous channel format allowed in the 160 MHz SU PPDU.

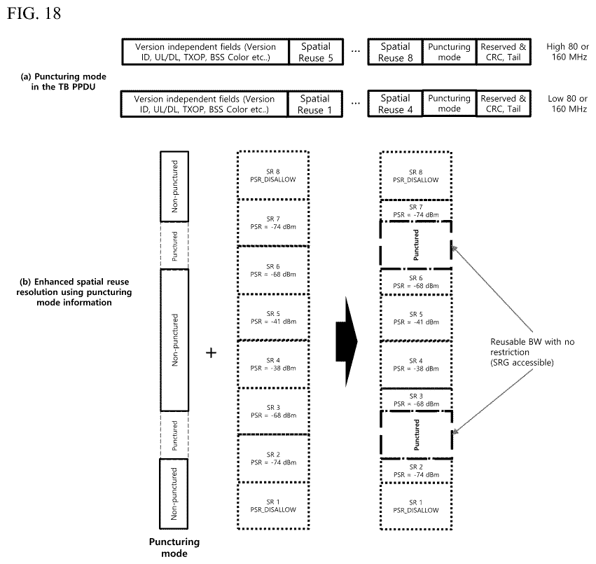

FIG. 18 illustrates an example of a TB PPDU including a puncturing mode according to an embodiment of the present invention.

When a puncturing mode is signaled through a trigger frame, an STA may include information on the puncturing mode acquired through the trigger frame in a TB PPDU of the STA when configuring the TB PPDU of the STA. For example, as illustrated in part (a) of FIG. 18, when a puncturing mode field is included in a signaling field of a TB PPDU, an OBSS receiving the corresponding TB PPDU may recognize a discontinuous format of a channel occupied by all TB PPDUs transmitted together with the TB PPDU, only through 20 MHz TB PPDU signaling information acquired through a primary channel of the OBSS.

In addition, the information on the puncturing mode may be used so that a frequency area corresponding to a spatial reuse value can be more minutely divided. For example, when information on whether a part of a BW area corresponding to a spatial reuse field is punctured is acquired through puncturing mode information, a BW corresponding to the spatial reuse field may only correspond to an area remaining after excluding a bandwidth punctured through information on the puncturing mode.

As illustrated in part (b) of FIG. 18, when information on whether a part of the BW is punctured is identified through the puncturing mode information of the puncturing mode field, information on the spatial reuse field corresponding to each BW may be applied only to the remaining unpunctured BW among the corresponding BWs.

<Dynamic RU TB PPDU>

UL MU (UL MU-MIMO or UL OFDMA) transmission using a trigger frame and a TB PPDU allows multiple STAs to simultaneously perform UL transmission to reduce contention between STAs while it is effective to solve an excessive overhead problem which may be caused by short PPDU (UL) transmission of a single STA. However, unlike general UL PPDU transmission, it is limited that each STA needs to perform UL transmission by utilizing an RU allocated through a trigger frame from 0 an AP through the trigger frame, without being based on a channel state (IDLE or BUSY) of each STA.

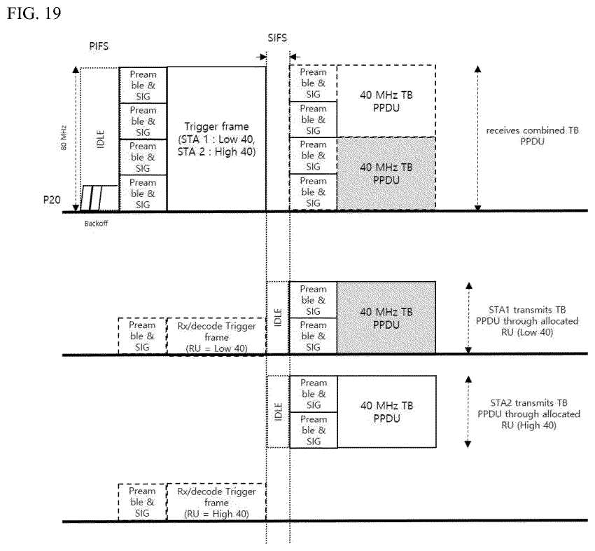

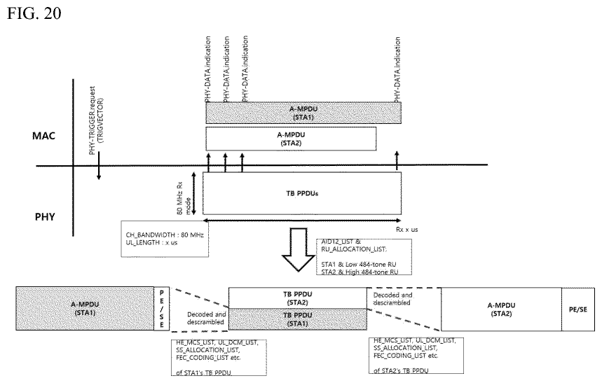

The above-described problem which limits RU selection on the STA side may be caused because a TB PPDU reception procedure on the AP side is different from a general reception procedure. In order to help understanding of a TB PPDU reception process of the AP, an embodiment for a procedure of responding through a TB PPDU by STAs having received a trigger frame, and an operation of receiving TB PPDUs transmitted by an each of the STAs via UL is described below with reference to FIGS. 19 and 20.

FIG. 19 illustrates an example of a procedure of responding through a TB PPDU and allocation of a resource unit through a trigger frame according to an embodiment of the present invention.

Referring to an embodiment of FIG. 19, an AP may transmit a trigger frame by utilizing an 80 MHz band identified as in an IDLE state, so as to allocate low 40 MHz and high 40 MHz RUs (each corresponding to 484-tone size RU) to STA1 and STA2, respectively. In this case, the trigger frame allocates RUs located in different frequencies to two STAs, and thus the trigger frame may be understood as a trigger frame for a UL OFDMA TB PPDU.

Each of STA1 and STA2 having received the trigger frame may decode the trigger frame and then identify that the trigger frame includes two user information fields and one of the two user information field corresponds to its own user information field. In this case, each STA may recognize its own user information field on the basis whether an AID12 subfield of the user information field includes information (for example, its own AID LSB 12 bits) related to its own AID.

STA1 may identify that an RU allocated to STA1 is a 484-tone RU located in low 40 MHz, through an RU allocation subfield included in its own user information field, and STA2 may recognize that an RU allocated to STA2 in the same manner as STA1 is a 484-tone RU located in high 40 MHz.

In addition, the trigger frame may include not only the information related to the RU (or spatial stream (SS)) allocated to each STA, but also PPDU length information and various encoding parameters which need to be applied when a TB PPDU is generated as a response to the trigger frame. Each STA may identify the RU allocated to each STA by decoding the trigger frame, and then apply an encoding parameter indicated through the trigger frame to generate a TB PPDU. The generated TB PPDU of each STA may be simultaneously transmitted via UL, and the AP may receive a UL OFDMA PPDU with which the TB PPDU transmitted by each STA is aggregated.

In consideration of the transmission of the trigger frame and the UL OFDMA PPDU reception procedure upon the transmission of the trigger frame, which are briefly described above, the AP needs to separate the received OFDM TB PPDU into TB PPDUs of respective STAs to acquire the TB PPDU transmitted by each STA via UL. However, the AP MAC corresponding to an entity for generating the trigger frame knows the format and the location of the RU allocated to each STA by the AP MAC itself, but the AP PHY corresponding to an entity for decoding and separating the ODFMA TB PPDU cannot know the configuration of the OFDMA TB PPDU that the AP PHY itself receives. Accordingly, the conventional 11ax standard defines a procedure in which a MAC sublayer of an AP generates a trigger frame and performs transmission by requesting the same from a PHY layer, and then provides the PHY layer with information required to receive a TB PPDU expected to be received as a response to the transmitted trigger frame.

In the 11ax, after performing a transmission request for the trigger frame, the MAC issues the PHY-TRIGGER.request primitive before the TB PPDUs of the STAs are received as a response to the trigger frame requested transmission of the TB PPDU. In this case, PHY-TRIGGER.request is issued to request, from the PHY entity, a configuration of a parameter for reception of the TB PPDU

The PHY-TRIGGER.request primitive provides a TRIGVECTOR parameter, and the TRIGVECTOR parameter includes BW information (CH_BANDWIDTH) and L-SIG length information (UL_LENGTH) of predicted TB PPDUs. In this case, the PHY performs a preparation operation for reception of TB PPDUs, such as configuring a BW of an RX mode by using the BW information and length information of the TB PPDUs transferred from the MAC.

In addition, the TRIGVECTOR parameter includes AID12_LIST and RU_ALLOCATION_LIST of STAs having RUs allocated through the trigger frame. The AID12_LIST and RU_ALLOCATION_LIST may be used to distinguish a subcarrier in which a TB PPDU of each STA exists from the TB PPDUs (OFDMA UL_PPDU) received from multiple STAs by the PHY, and as a result, the PHY may separate TB PPDUs of respective users from the TB PPDUs.

TRIGVECTOR includes an encoding-related parameter commonly applied to TB PPDUs, MCS information utilized for the TB PPDUs of respective STAs, etc., and the PHY may decode the TB PPDUs of the respective STAs by utilizing encoding 0 related information.

As described above, when it is considered that the MAC provides the PHY with information related to a TB PPDU expected to be received, the TB PPDU reception procedure may be different from a general PPDU reception procedure. In other words, unlike the general PPDU reception, the PHY may wait for reception of 5 TB PPDUs and perform decoding on the basis of the information provided by the MAC, instead of acquiring information for decoding of TB PPDUs that is being received from an SIG field and a preamble of the TB PPDUs that is being received.

FIG. 20 illustrates an example of a method for receiving a TB PPDU on the basis of a trigger frame according to an embodiment of the present invention.

Referring to FIG. 20, AP PHY may receive TRIGVECTOR transferred from a MAC sublayer and receive TB PPDUs predicted on the basis of information included in the TRIGVECTOR.

Specifically, as illustrated in FIG. 20, the MAC sublayer issues the PHY-TRIGGER.request primitive to a local PHY entity. In this case, a time point at which the PHY-TRIGGER.request primitive is issued may be after the MAC has requested transmission of the trigger frame from the PHY and before a TB PPDU is received as a response to the trigger frame.

The PHY having received the PHY-TRIGGER.request primitive from the MAC may recognize that the BW of the TB PPDUs predicted to be received is 80 MHz, through a CH_BANDWIDTH parameter among parameters of the TRIGVECTOR. Thereafter, the PHY performs reception of the 80 MHz TB PPDUs and separates TB PPDUs of respective users from the TB PPDUs received via OFDMA, by using AID12_LIST and RU_ALLOCATION_LIST among the TRIGVECTOR parameters received from the MAC.

A process of separating the TB PPDUs of respective STAs from the TB PPDUs may be performed by utilizing a AID12_LIST parameter and a RU_ALLOCATION_LIST parameter among the parameters of the TRIGVECTOR. For example, as illustrated in FIG. 20, the AID12_LIST parameter may include AID LSB 12 bits of STA1 and STA2 as an entry. Accordingly, the PHY may recognize that the TB PPDUs that is being received are aggregated with a TB PPDU of STA1 and a TB PPDU of STA2. In addition, the PHY may identify information on the formats of the TB PPDUs of STA1 and STA2 through RU_ALLOCATION_LIST, and identify that an RU of an STA 1 corresponds to a 484-tone RU located in a low 40 MHz band and an RU of STA2 corresponds to a 484-tone RU located in a high 40 MHz. Accordingly, the PHY may identify the locations of the RUs through which TB PPDU1 and TB PPDU2 transmitted by STA1 and STA2 are transmitted and then attempt to perform decoding for the respective PPDUs.

In consideration of the above-described TB PPDU reception procedure, reception of TB PPDUs may be completed with only information transferred from the MAC to the PHY of the reception device. Accordingly, a reception device may receive TB PPDUs of respective STAs without decoding a SIG field and a preamble of each TB PPDU transmitted by each of the STAs.

For this reason, a HE-SIG-A field of the 11ax TB PPDU may be configured to include information (a BSS color, a TXOP, and four spatial reuse fields) for helping an operation of OBSS devices, rather than information required for reception and decoding of the TB PPDU.

Unlike the general PPDU reception procedure, reception of the TB PPDU may be performed on the basis of information provided to the PHY by the MAC of the reception device corresponding to an entity which has generated the trigger frame, rather than information acquired from the SIG field and the preamble of the PPDU that is being received.

Accordingly, when an STA having received a trigger frame encodes a PPDU by using an RU other than an RU allocated through the trigger frame or utilizing a parameter value other than a parameter value indicated through the trigger frame, a device for performing reception of TB PPDUs after transmission of the trigger frame cannot receive and process the TB PPDUs.

When a specific STA generates a TB PPDU by using an RU other than an RU allocated through a trigger frame and transmits the same via UL, the AP PHY having transmitted the trigger frame may fail to separate the TB PPDU transmitted by the specific STA from OFDMA TB PPDUs received from multiple STAs. In addition, when a specific STA encodes a PPDU by utilizing a parameter value other than a parameter value indicated through a trigger frame, the AP PHY having transmitted the trigger frame may separate a TB PPDU of the specific STA from received OFDM TB PPDUs but may fail to perform decoding. In order to prevent failure in reception of the TB PPDU, STAs receiving a trigger frame and then transmitting a TB PPDU as a response thereto may be limited to generate and transmit the TB PPDU by only utilizing an indicated parameter value and an RU allocated to each of the STAs.

Limiting the STA to receive a trigger frame and respond with a TB PPDU by only utilizing the indicated parameter and the RU allocated through the trigger frame is necessarily required to secure that the AP can successfully receive and decode the TB PPDU responded by the STA, but the STA may not be able to efficiently utilize the RU allocated by the STA itself in a situation where a hidden node of the AP exists on the STA side.

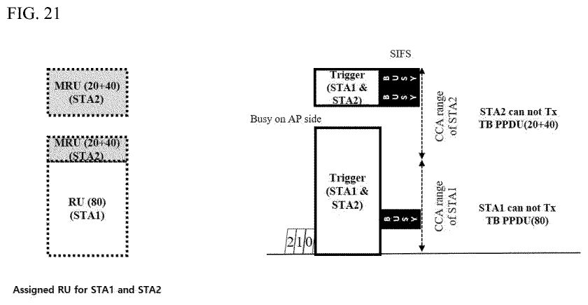

FIG. 21 illustrates another embodiment of a method for receiving a TB PPDU on the basis of a trigger frame according to an embodiment of the present invention.

Referring to FIG. 21, when a hidden node of an AP exists on an STA side, an RU allocated through a trigger frame of the AP cannot be used for transmission of a TB PPDU by the STA.

Specifically, the AP may allocate a 996-tone size RU located in the low 80 MHz band to STA1 through the trigger frame, and allocate a 242+(242)+484-tone size RU located in the high 80 MHz band to STA2. In this case, among the 160 MHz band divided and allocated to STA1 and STA2, a 20 MHz band (242-tone size RU) not allocated to both STAs may be a band in which a subchannel determined as “BUSY” as a result of CCA performed before the AP transmits the trigger frame exists.

The frame transmitted by the AP may be received by STAs of the BSS operated by the AP, and each of STA1 and STA2 may recognize its own user information field among one or more user information fields included in a user information list field of the received trigger frame, through an AID field. In this case, STA1 may recognize that an RU allocated to STA1 is a low 80 MHZ band 996-tone size RU through an RU allocation subfield existing in the identified user information filed of STA1, and STA2 may recognize that an RU allocated to STA2 is a 242+(242)+484-tone size RU located in the high 80 MHz band in the same manner as STA1.

STA1 and STA2 having recognized RUs allocated to STA1 and STA2 through the trigger frame may receive the trigger frame and then need to perform CCA during an SIFS corresponding to a timer interval until responding of a TB PPDU. In this case, the CCA may be ED-based CCA. An operation of performing the ED-based CCA by the STA may be performed only when a CS required subfield shown in a common information field of the received trigger frame is 1. The ED-based CCA may include one of or both virtual carrier sensing (NAV) and energy detection of per 20 MHz CCA sensitivity.

In addition, STAs performing the ED-based CCA after receiving an RU allocated through the trigger frame may perform the ED-based CCA for the entire BW band of the PPDU including the trigger frame, or may perform ED-based CCA only for subchannel(s) including the RUs allocated to the STAs through the trigger frame.

As a result of the CCA performed by the STA having the RU allocated through the trigger frame, when it is considered that at least one of 20 MHz subchannels existing in the allocated RU is “BUSY”, transmission of the TB PPDU using the allocated RU cannot be performed.

STA1 and STA2 may perform CCA for four 20 MHz subchannels in the low 80 MHz band and three 20 MHz subchannels in the high 80 MHz band, which are allocated to STA1 and STA2. As a result of perform CCA for subchannels existing in the RUs allocated to both STAs, both STAs may fail to identify that some (one subchannel in a case of STA1 and two subchannels in a case of STA2) of the subchannels existing in the RUs allocated to both STAs are BUSY. In this case, both STA1 and STA2 may fail to transmit the TB PPDU.

When there is a subchannel considered as BUSY among 20 MHz subchannels in which an RU allocated to an STA through a trigger frame exists, use of subchannels considered as in an IDLE state among the subchannels is also restricted. For this reason, restriction that an STA receiving RU allocation through a trigger frame and transmitting a TB PPDU via UL needs to transmit the TB PPDU by utilizing all RUs allocated to the STA may be a major cause of reduction in efficiency of UL OFDMA transmission performed through an exchange between the trigger frame and the TB PPDU.

In order to solve such a problem of restriction of usability of the STA for the RU allocated through the trigger frame, the present invention proposes a procedure of allowing an STA to adaptively changing an RU for transmitting a TB PPDU on the basis of an allocated RU and a CCA result of 20 MHz subchannels existing the allocated RU.

In the present invention, the meaning of the term “20 MHz subchannel existing in an RU” may be used to indicate a 20 MHz subchannel in which a subchannel corresponding to an RU exists. That is, the number of 20 MHz subchannels included in the 26, 52, 106, and 242-tone size RUs is 1, and the number of 20 MHz subchannels included in each of a 484-tone RU and a 996-tone RU is two, wherein a total number of 20 MHz subchannels included in 484-tone and 996-tone RUs are four. In this case, the format of a final use RU determined by the STA on the basis of the CCA result may be determined in consideration of a pre-agreed RU configuration. The above-mentioned method for determining the format of the final use RU is described through embodiments below in detail. Briefly, according to an aspect of the present invention, an STA having received an RU allocated through the trigger frame may transmit a TB PPDU via UL by utilizing all or some of 20 MHz subchannels which are IDLE and exist within the allocated RU on the basis of a CCA result, instead of utilizing the allocated RU without any change.

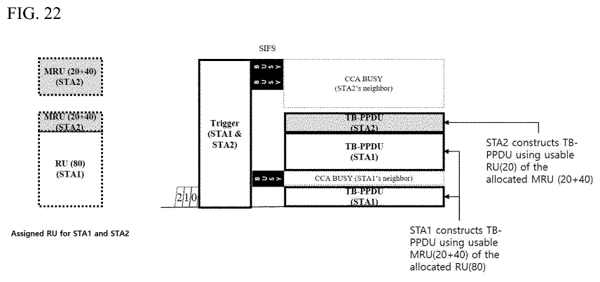

FIG. 22 illustrates another example of a method for receiving a TB PPDU on the basis of trigger frame according to an embodiment of the present invention.

Referring to FIG. 22, a device having received a trigger frame may transmit (respond with) a TB PPDU by utilizing only some of RUs allocated through the trigger frame.

Specifically, STA1 and STA2 may transmit the TB PPDU via UL by using only subchannels remaining after excluding subchannels considered as BUSY as a result of CCA, among RUs allocated to STA1 and STA2. An operation of selectively changing, by an STA, a configuration of an RU to be utilized in TB PPDU generation and transmission according to the CCA result for the 20 MHz subchannel existing in the RU allocated to the STA may be implemented without any particular performance problems. This is because the operation of the STA as shown in FIG. 22 can be implemented by only adding, in a process of generating a TB PPDU after receiving a trigger frame by an STA, a procedure of performing updating according to the CCA result, instead of utilizing the RU configuration identified through the trigger frame without any change.

While the operation on the STA side can be simply implemented, the AP may fail to successfully decode the OFDMA PPDU (TB PPDUs) when the RU allocated to each STA through the trigger by the AP and the RU occupied by the TB PPDU transmitted by each STA does not match, as shown in the embodiment of FIG. 22.

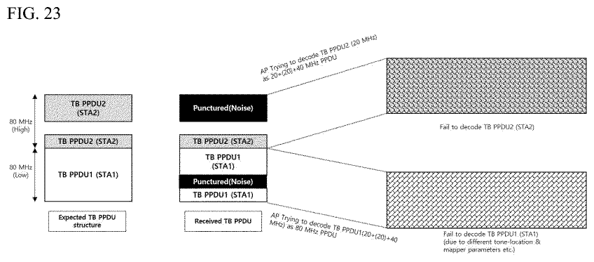

FIG. 23 illustrates another example of a method for receiving a TB PPDU on the basis of a trigger frame according to an embodiment of the present invention.

Referring to FIG. 23, an AP may fail to perform UL OFDMA reception when the AP has an RU configuration in which an RU allocated through a trigger frame and an RU through which a TB PPDU corresponding to a response to the trigger frame is transmitted are different.

In consideration of the TB PPDU reception procedure on the AP side, described in through FIG. 20, PHY of the AP may predict that TB PPDU1 of STA1 is received through a 996-tone size RU located in the low 80 MHz and TB PPDU2 of STA2 is received through a 242+484-tone size located in the high 80 MHz band, on the basis of TRIGVECTOR received from the MAC.

Accordingly, when the UL OFDMA PPDU starts to be received, the AP may predict that 80 MHz TB PPDU1 exists in the low 80 MHz band and attempt to perform decoding of an 80 MHz PPDU, and may predict that 20+(20)+40 MHz TB PPDU2 exists in the high 80 MHz band and attempt to perform decoding of a 20+(20)+40 MHz PPDU. In this case, TB PPDU1 and TB PPDU2 transmitted by STA1 and STA2, respectively, may have a different format from a PPDU for which the AP attempts to perform decoding. Accordingly, the AP fails to perform decoding of the TB PPDU transmitted as a response to the trigger frame.

As described above, in order to solve the problem that a TB PPDU transmitted via UL according to an RU configuration by the determination of each STA, other than a configuration of the RU allocated through the trigger frame cannot be decoded on the AP side, a procedure or signaling of allowing the AP to recognize the format of the RU utilized by each STA is required. Accordingly, the present invention provides a method for allowing the AP to recognize the format (RU configuration) of a TB PPDU that is being received, through a signaling field of the TB PPDU when receiving the TB PPDU, and a procedure of recognizing and estimating a format of a TB PPDU transmitted by each STA, through per 20 MHz CCA by the AP.

To simply the description of the invention below, configuring a TB PPDU and performing UL transmission by an STA having received RUs allocated through the trigger frame as describe above, by utilizing only some RUs included in the allocated RUs for reasons of implementation or as a result of CCA, instead of utilizing the RUs allocated the STA without change, may be referred to as dynamic TB PPDU configuration and UL transmission. As an embodiment of the dynamic TB PPDU configuration, the dynamic TB PPDU configuration means that an STA having received allocation of an 80 MHz RU configures a TB PPDU by utilizing a 60(20+40) MHz RU remaining after excluding a 20 MHz subchannel determined as BUSY, as a result of CCA for the allocated 80 MHz RU. In this case, the RU utilized when configuring a dynamic TB PPDU by each STA may have a format in which even some subchannels determined as IDLE among subchannels in the allocated RU are excluded due to the limitation of the multiple-RU (M-RU) configuration allowed in the standard or implementation constraints as well as the CCA result. In addition, in addition to the CCA result, the limitation of the M-RU configuration, or implementation constructions, in a case where there is no great amount of data to be transmitted by each STA, each STA may configure the dynamic TB PPDU by utilizing some RUs only, instead of using all available RUs.

<Embodiment of Trigger Frame Format for Dynamic TB PPDU>

Unlike the conventional 11ax AP, an AP receiving dynamic TB PPDU(s) as a response to a trigger frame after transmitting the trigger frame needs to identify a configuration of an RU through which a dynamic TB PPDU transmitted by each STA is transmitted, instead of only depending on information on an RU allocated to each STA through the trigger frame. To this end, each STA includes, in a preamble, information on an RU through which a dynamic TB PPDU configured by each STA is transmitted, and the AP receives/decodes the preamble of the dynamic TB PPDU transmitted by each STA, so that each STA can identify a format of the dynamic TB PPDU transmitted by each STA. In this case, the AP may identify a format of the entire RU in which the dynamic TB PPDU is shown only when the AP decodes at least one subchannel in which the preamble of the dynamic TB PPDU transmitted by each STA is shown.

Accordingly, when multiple dynamic TB PPDUs are transmitted through a single trigger frame as a response, the AP needs to decode a preamble of each of the responding dynamic TB PPDUs, and the operation of decoding multiple preambles needs to be performed in parallel, and thus a high level of implementational complexity is required on the AP side.

When the AP cannot process all preambles of the dynamic TB PPDUs transmitted by each STA, the AP cannot decode dynamic TB PPDUs having preambles which have failed to be properly processed, among the dynamic TB PPDUs. Accordingly, the AP needs to explicitly indicate to STAs whether a dynamic TB PPDU can be transmitted as a response while simultaneously allocating RUs to the STAs through the trigger frame.

In addition, reception of a dynamic TB PPDU is performed in the PHY, and thus the AP MAC may configure a trigger frame, request transmission from the PHY, and transfer DYNAMIC_RU_LIST indicating whether the dynamic TB PPDU can be received in each EU, together with RU_ALLOCATION_LIST corresponding to a parameter of TRIGVECTOR.

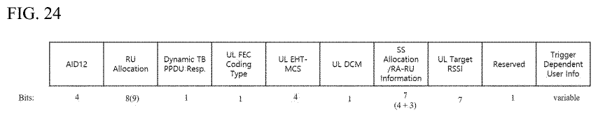

FIG. 24 illustrates an example of a user information field of a trigger frame according to an embodiment of the present invention.

Referring to FIG. 24, an STA having an RU allocated through a trigger frame may recognize, through a user specific field of the trigger frame, whether a dynamic TB PPDU is allowed as a response.

Reception of a dynamic TB PPDU by an AP may be an operation not supported in the conventional 11ax standard, and may be a factor causing an increase in the implementation complexity of the AP receiving UL OFDMA PPDUs.

Accordingly, the AP may signal whether a dynamic TB PPDU response is allowed as a response to the trigger frame transmitted by the AP, in consideration of the capability of the AP.

In an embodiment, the AP may indicate, by using a specific field of a trigger frame, whether dynamic TB PPDUs of STAs responding with TB PPDUs after receiving the trigger frame are allowed to be transmitted.

Specifically, in order to indicate to each of the STAs, by using the specific field included in the trigger frame, whether the dynamic TB PPDU response is allowed, the AP may use a user information field of the trigger frame.

As illustrated in FIG. 24, the user information field of the trigger frame may include AID12, RU allocation, dynamic TB PPDU response, UL FED coding type, UL EHT-MCS, UL DCM, SS allocation/RA-RU information, UL target RSSI, reserved, and trigger dependent user info subfields.

The AID12 field indicates, through the user information field, AID LSB 12 bits of an STA which receives RU allocation and needs to respond with a TB PPDU, and the RU allocation subfield indicates the location and the size of an RU to be used by the STA which needs to respond with the TB PPDU. In this case, the RU allocation subfield may be interpreted to be aggregated with UL BW included in a common information field of the trigger frame.

In addition, the user information field of the 11be trigger frame may include subfields having functions mostly identical or similar to those of the trigger frame in the 11ax, and the RU allocation subfield and the SS allocation/RA-RU information subfield may be used to indicate multiple-RU (M-RU) and the number (16) of antennas added to the 11be.

The dynamic TB PPDU response subfield among subfields of the user information field may indicate whether it is allowed an STA which receives RU allocation through the corresponding user information field and needs to respond with a TB PPDU responds with the dynamic TB PPDU by utilizing a part the allocated RU according to a result of CCA of the STA. As an embodiment, when a dynamic TB PPDU response subfield is configured as 1, the dynamic TB PPDU response may be allowed for the STA having received the corresponding user information field, and when the subfield is configured as 0, the dynamic TB PPDU response may not be allowed.

As another embodiment, the AP may not separately perform signaling of whether the dynamic TB PPDU response is allowed to each STA. In this case, each STA may operate by recognizing that the dynamic TB PPDU response is allowed only when each STA receives allocation of a 40 MHz or higher SU-RU through the trigger frame.

Alternatively, as another embodiment, the AP may indicate to all STAs whether the dynamic TB PPDU response is allowed, through a common information field (of the trigger frame) rather than the user information field of each STA. When the dynamic TB PPDU response is allowed through the common information field of the trigger frame and the STA having received allocation of a 40 MHz or higher RU has capability to respond with the dynamic TB PPDU, the STA may configure the dynamic TB PPDU to respond to the trigger frame.

<Method for Determining Whether to Allow Dynamic TB PPDU>

In addition to the above-described restrictions related to decoding capability of the AP, there may be a case where the dynamic TB PPDU is not allowed. When the RU allocated to a specific STA through the trigger frame corresponds to a 20 MHz RU or a RU (242-tone size RU) in a bandwidth lower than 20 MHz, the STA having received allocation of the RU may fail to configure the dynamic TB PPDU.

When it is assumed that the STA has received the 20 MHz RU, the STA may perform CCA for the 20 MHz subchannel existing in the 20 MHz RU and determine that the entire 20 MHz RU is IDLE or BUSY. Accordingly, the STA having received the allocation of the 20 MHz RU has no ground to dynamically utilize the RU allocated to the STA according to a result of the CCA. In addition, even though the result of the CCA for each RU in the 20 MHz RU can be acquired, a 20 MHz unit preamble of a TB PPDU needs to be configured, and thus there is a problem that a preamble except for a small RU determined as BUSY cannot be transmitted. Similarly, it is also restricted that STAs each having received allocation of an RU in a bandwidth lower than 20 MHz perform dynamic TB PPDU transmission for the same reason as for the above-described STA having received allocation of the 20 MHz RU.

In addition, when the AP has allocated the same RU to multiple STAs through the trigger frame, the TB PPDUs transmitted by respective STAs need to have the same preamble and RU configuration when being transmitted as a response.

When multiple STAs having received allocation of the same RU respond with dynamic TB PPDUs transmitted through different RU configurations, the AP receiving the dynamic TB PPDUs may not be able to distinguish a format of the dynamic TB PPDU transmitted by each of the STAs. Accordingly, when the AP allocates a specific RU to the multiple STAs, the AP may indicate the dynamic TB PPDU resp. subfield shown in the user information field of each STA as 0 so as to prevent respective STAs from responding with the dynamic TB PPDUs through different RU configurations.

Alternatively, when an RU allocated to each STA is a 40 MHz or higher RU, the STA may perform a procedure of identifying whether the RU allocated to the STA is a multi-user (MU) RU allocated to all other STAs except for the STA itself. In this case, each STA may respond with the dynamic TB PPDU only when the RU allocated to the STA is a single-user (SU) RU allocated only to the STA itself.

In addition, even though different RUs are allocated to respective STAs, when the allocated different RUs are RUs existing within the same 80 MHz RU boundary, the dynamic TB PPDU response can be restricted to the STAs. This may be because of the restriction that different preamble cannot exist in an 80 MHz segment. In a situation an AP has allocated, through the trigger frame, two 40 MHz RUs existing within the 80 MHz segment to two STAs, respectively, when each STA transmits a dynamic TB PPDU, each STA may configure different preambles and respond. In this case, there may be two different preambles in the 80 MHz segment, and this may be an operation violating the rules regulated in the 11be. In this case, the above-described dynamic TB PPDU response restriction related to the preamble regulation may be applied only to an embodiment related to the dynamic TB PPDU preamble among the embodiments of the present invention below.

In addition, the above-described operation of the STA receiving or responding with the dynamic TB PPDU may be an operation which is difficult to be implemented in an STA having limited hardware configurations, and accordingly, the AP and the STA may exchange whether an EHT-capability element supports a dynamic TB PPDU response and information on the supported RU configuration. In this case, when the dynamic TB PPDU field of the EHT-capability element is indicated as 1, it may mean that the corresponding STA may configure a dynamic TB PPDU and respond with the same.

<Embodiment of TB PPDU Format and Trigger Frame for Exchanging of Dynamic TB PPDU>

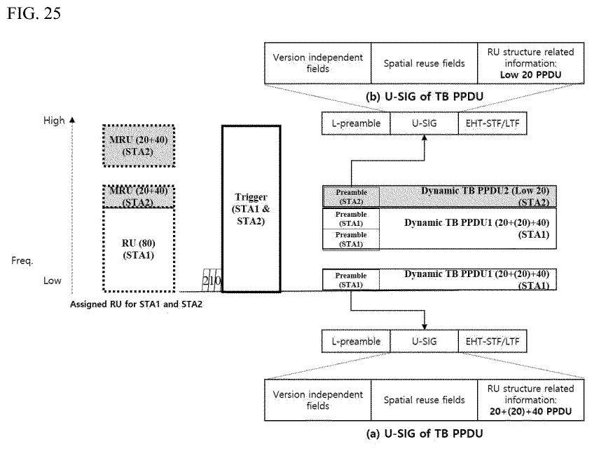

FIG. 25 illustrates an example of a method for transmitting a TB PPDU on the basis of a trigger frame according to an embodiment of the present invention.

Referring to FIG. 25, STAs each having received allocation of an RU through a trigger frame may respond through a dynamic TB PPDU.

Specifically, in an operation of allocation an RU through a trigger frame by an AP and performing responding of a dynamic TB PPDU by STA1 and STA2 each having received allocation of the RU through the trigger frame, the same situation as a CCA situation of each STA shown through the embodiment of FIG. 22 is assumed.

As illustrated in FIG. 25, each STA may respond with information on an RU configuration utilized by each STA through a U-SIG field of a dynamic TB PPDU transmitted by each STA as a response. Referring to part (a) of FIG. 25, STA1 may indicate that STA1 responds with dynamic TB PPDU1 by utilizing a 20+(20)+40 MHz RU except for the second 20 MHz subchannel from an 80 MHz RU corresponding to an RU allocated to STA1, and STA2 may indicate that STA2 responds with dynamic TB PPDU2 by utilizing a 20 MHz RU located at a lower part at the frequency location, among RUs allocated to STA2. In this case, when the AP decodes at least one preamble existing in subchannels of dynamic TB PPDUs transmitted by STA1 and STA2, respectively, the AP may recognize that dynamic TB PPDU1 of STA1 is to be received in the 20+(20)+40 MHz RU existing in the low 80 MHz and dynamic TB PPDU 2 of STA2 is to be received in the low 20 MHz RU among RUs existing in the high 80 MHz.

As described above, the method for signaling, by each STA, information on the format of an RU utilized when configuring a dynamic TB PPDU by each STA has a problem in that the representation of the formats of some RUs may be limited in consideration of the limited lengths of the U-SIG field. When an RU allocated to an STA is 320 MHz and the STA may configure a dynamic TB PPDU by freely utilizing the allocated 320 MHz RU in units of 20 MHz RU units, 16 bits need to be allocated to accurately represent the format of the dynamic TB PPDU which can be configured by the STA having received allocation of the 320 MHz RU. However, the U-SIG includes a version independent field and needs to include a puncturing mode field, a spatial reuse field for the OBSS, and the like, and thus it is impossible to spend 16 bits to indicate the format of the dynamic TB PPDU as described above.

For this reason, the size of a field related an RU format which can be utilized to indicate the format of the dynamic TB PPDU may be limited, and there may be a configuration of excluding signaling for a specific RU combination. However, in the 11be, the combination is limited to an RU combination (M-RU) which can be utilized by a single STA in consideration of the implementation complexity and efficiency aspects, and most dynamic TB PPDU formats can be represented by using only 4 bits, regardless of the size of the RU allocated by the STA due to the limited RU combinations.

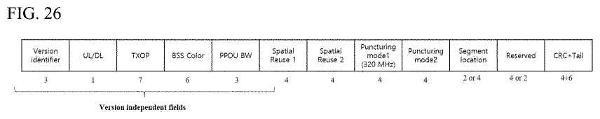

FIG. 26 illustrates an example of a format of a U-SIG field of a TB PPDU according to an embodiment of the present invention. The format of the U-SIG field of the TB PPDU illustrated in FIG. 26 may presume that the U-SIG of the TB PPDU may be indicated by different values for each 80 MHz segment.

Referring to FIG. 26, the U-SIG of the TB PPDU may include version independent fields. The version independent fields may be fields commonly included in the next-generation Wi-Fi PPDU, regardless of the PHY protocol version and the PPDU type, as described through the embodiment of FIG. 8 above.

In addition, spatial reuse 1 and 2 fields shown in the U-SIG of the TB PPDU may indicate spatial reuse values to be applied in the 80 MHz segment in which the TB PPDU is transmitted.

In addition, puncturing modes 1 and 2 may be shown in the TB PPDU U-SIG, and puncturing mode 1 may be a field in which a UL Puncturing mode field value transferred to each STA through the common information field of the trigger frame is copied/moved without change and is shown. The UL Puncturing mode field may indicate a value of a puncturing mode shown through prediction of the format of a UL OFDMA PPDU to be received by an AP as a response to a trigger frame in a process in which the AP generates the trigger frame. That is, the puncturing mode 1 field may be information provided to help operations of other devices in the same manner as the spatial reuse field, instead of information required for the AP to receive the dynamic TB PPDU. Accordingly, the puncturing mode 1 field has the same value for all (dynamic) TB PPDUs transmitted through the trigger frame as a response.

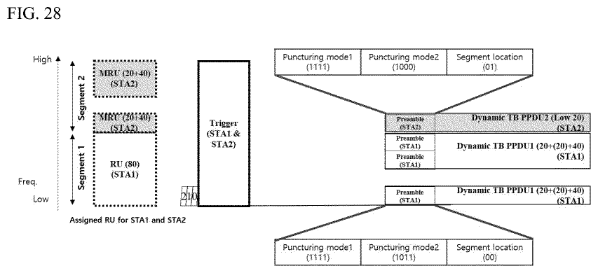

The puncturing mode 2 field may be a field in which an STA responding with the dynamic TB PPDU shows the format of an RU utilized when configuring the dynamic TB PPDU by the STA, and accordingly, puncturing mode 2 fields of the (dynamic) TB PPDU U-SIG, transmitted (in different 80 MHz segments) by different STAs may have different values. An embodiment of performing signaling by utilizing the puncturing mode 2 field is described through FIG. 28 below.

When an OBSS device detects a preamble of a TB PPDU from a specific segment, the segment location field provides information indicating the order of a segment where the TB PPDU included in the detected preamble is located in an operating BW of an AP receiving the TB PPDU. An embodiment of performing signaling by utilizing the segment location field is described through an embodiment of FIG. 28 below.

As described above, a RU combination which can be utilized in the dynamic TB PPDU configuration by the STA having received allocation of the RU through the trigger frame may be limited to a specific format in consideration of the implementation complexity and efficiency aspects. For example, the RU which can be allocated to a single STA through the trigger frame may be limited to small RUs (26, 52, 78, 106, and 132-tone size RUs) and 20, 40, 60, 80, 120, and 160 MHz RUs (corresponding to 242, 484, 996, 484+996, and 996×2-tone size RUs, respectively). That is, the 100 MHz RU (996+242-tone size RU) and the 140 MHz RU (242+484+996-tone size RU) have gains not greater than the 80 MHz RU and the 120 MHZ RU, respectively, and may be thus excluded to increase the implementation complexity. In this case, the type of RU allocated to a single STA through the trigger frame of the 240/320 MHz PPDU may be limited for the same reason above. In this case, the RU type in the limited format may be a mandatory multiple-RU.

According to an embodiment of the present invention, when a single STA configure a dynamic TB PPDU by utilizing a part of an RU allocated to the single STA, the configured dynamic TB PPDU may be limited to have limited formats, and the limited format of the TB PPDU may be signaled in a 4-bit size bitmap.

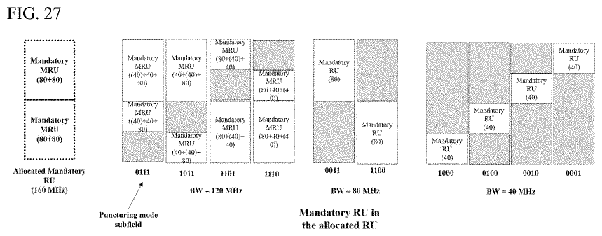

FIG. 27 is an example of signaling and configuration of a resource unit for transmission of a TB PPDU according to an embodiment of the present invention.

Referring to FIG. 27, an STA may receive a 160 MHz RU through a trigger frame, and an AP having generated and transmitted the trigger frame may already identify the size and the location of the RU allocated to the STA.

After receiving the trigger frame, when the STA has performed CCA for eight 20 MHz subchannels included in the allocated 160 MHz RU and one or all of two subchannels existing at the lowest frequency location is determined as BUSY, puncturing mode2 of a dynamic TB PPDU U-SIG may be indicated as 0111. In this case, even when only one of the two subchannels existing at the lowest frequency location is BUSY, the STA may need to configure a dynamic TB PPDU by utilizing a 120 MHz RU (484+996-tone size RU) remaining after excluding the two subchannels from the allocated 160 MHz RU.

As another embodiment, as a result of performing CCA for eight 20 MHz subchannels included in the allocated 160 MHz RU, when the STA can utilize only a 80 MHz RU due to the above-describe RU format constraints, the puncturing mode2 field may be configured as 0011 or 1100, and the STA may configure a dynamic TB PPDU and perform UL transmission by utilizing the 80 MHz RU only.

In consideration of the above-described puncturing mode 2 (RU structure of dynamic TB PPDU) signaling method utilizing a 4-bit size bitmap of the present invention, the STA may identify that the minimum size of an RU which can be indicated by utilizing the puncturing mode 2 field is ¼ of the size of the RU allocated to the STA. Accordingly, as described in the present embodiment, when the STA has received allocation of the 160 MHZ RU and only of eight subchannels included in the RU has been determined as IDLE, the STA may need to abandon UL transmission utilizing the dynamic TB PPDU.

FIG. 28 illustrates an example of signaling of a segment location and a puncturing mode through a TB PPDU according to an embodiment of the present invention.

Referring to FIG. 28, an STA may receive allocation of an RU through a trigger frame transmitted through a 160 MHz band, and two STAs may transmit a response to the trigger frame through a dynamic TB PPDU of a U-SIG field including a puncturing mode and segment location field.

In FIG. 28, STA1 receives allocation of a 80 MHz RU corresponding to Segment 1 located at a lower frequency through the trigger frame, and STA2 receives allocation of a 20+(20)+40 MHz RU included in Segment 2 located at a higher frequency through the trigger frame. According to a CCA result and RU format constraints, STA1 and STA2 may configure TB PPDUs 1 and 2 by utilizing the 20+(20)+40 MHz RU and the 20 MHz RU, respectively, and perform UL transmission.

In this case, puncturing mode 1 fields included the U-SIG fields of the dynamic TB PPDUs transmitted by STA 1 and STA2 may have the same value, but for puncturing mode 2 fields and segment location fields of two dynamic TB PPDU may be configured as different values.

The puncturing mode 1 field included in the dynamic TB PPDU is a value indicated through a common information field of the trigger frame, and as described above, indicates format information of a UL OFDMA PPDU for which transmission of a response through the trigger frame is predicted. Accordingly, the puncturing mode 1 field indicates the same value for all TB PPDUs each transmitted through a single trigger frame as a response.

As described through the embodiment of FIG. 27 above, the configuration of the puncturing mode 2 field may be signaled with different values to indicate a format of an RU utilized by each STA. Accordingly, STA1 may perform signaling by configuring the puncturing mode 2 field as 1011 to indicate that dynamic TB PPDU1 has been configured by utilizing the 20+(20)+40 MHz RU located in Segment 1, and STA2 may perform signaling by configuring the puncturing mode 2 field as 1000 to indicate that dynamic TB PPDU2 has been configured by utilizing the 20 MHz RU located at the lowest frequency of Segment 2 in which an RU allocated to dynamic TB PPDU exists.

In addition, each STA may indicate information on the order of a segment of a TB PPDU transmitted by each STA among a BW in which TB PPDUs each transmitted as a response to the UL OFDMA are shown, by utilizing the segment location field. The segment location field may be provided so that STAs each having detected a preamble of a specific TB PPDU can identify information on a frequency area in which TB PPDUs transmitted together with the TB PPDU are shown. In this case, the segment location field may be interpreted together with a BW field that is another field included in the TB PPDU U-SIG. As an embodiment, when an STA identifies that a BW of a TB PPDU is 160 MHz in a preamble detected by the STA and the segment location field is 00, the STA may identify that the TB PPDU detected by the STA and TB PPDUs each transmitted as a response together with the detected TB PPDU are transmitted through a 160 MHz BW and the location of the detected TB PPDU is 80 MHz at the lowest frequency.

An embodiment of the present invention considers an embodiment in which a segment location field is 2 bits, and accordingly, four segments included in the maximum 320 MHz PPDU may be indicated as 00, 01, 10 and 11, respectively, from a segment at the lower frequency. As described in the embodiment of FIG. 27, when a specific STA receives allocation of an RU through two segments, the specific STA may configure the segment location field included in the U-SIG field of the TB PPDU according to the location of each segment with different values (e.g., 00 and 01).

As described above, there is a procedure in which an STA responding with a dynamic TB PPDU needs to configure a U-SIG field after determining an RU allocation and a CCA result performed by the STA itself, instead of configuring a TB PPDU U-SIG by utilizing values shown through a trigger frame requesting the dynamic TB PPDU.

Accordingly, an operation of the STA responding with the dynamic TB PPDU may be more complex than the operation of the STA responding with the 11ax TB PPDU, and in this process, a delay may occur and it may be difficult to respond with the TB PPDU within a predetermined time (an SIFS after the trigger frame).

In order to solve the problem above, when an AP allows a dynamic TB PPDU response for one or more STAs through a trigger frame, the AP may indicate that a response of the TB PPDU starts at a time point other than a time point after the SIFS. For example, when the AP indicates a delayed response field as 1 through a common info field of a trigger frame, STAs having received the trigger frame may respond with a TB PPDU after a PIFS other than the SIFS.

In FIG. 28, dynamic TB PPDUs 1 and 2 received as response to the trigger frame may have different U-SIG field configurations, and to identify the format of an RU each transmitted by dynamic TB PPDUs 1 and 2, the AP needs to decode at least one of subchannels in which two dynamic TB PPDUs 1 and 2 are shown. However, there is a problem in that the AP cannot identify a subchannel which has been excluded in each dynamic TB PPDU response process, among subchannels included in the RUs allocated by the AP to the respective STAs. Accordingly, it may be very difficult for the AP to implement the operation of decoding at least one subchannel in which each dynamic TB PPDU is shown, and to solve this problem, a subchannel which is to be mandatorily occupied when the dynamic TB PPDU is transmitted as a response may need to be preconfigured.

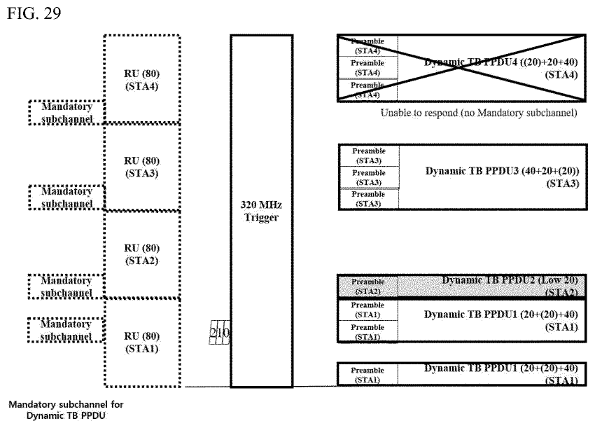

FIG. 29 illustrates an example of configuration and use of a subchannel for TB PPDU transmission according to an embodiment of the present invention.

Referring to FIG. 29, a situation in which an AP has allocated an 80 MHz RU located in each segment to each of STA1 to STA4 through a 320 MHz trigger frame and allows a dynamic TB PPDU response for each STA is considered. The AP may indicate, to each STA, a subchannel which needs to be occupied when a dynamic TB PPDU is transmitted as a response. For example, FIG. 29 illustrates a situation in which an AP has indicated to STA1 to occupy the third subchannel and indicated to each of STA2 and STA3 to occupy the first subchannel, wherein each STA needs to transmit a dynamic TB PPDU as a response by mandatorily occupying the subchannel indicated by the AP, among four subchannels of a segment in which an RU allocated to each STA is located. In a case of STA4 having received allocated of the 80 MHz RU located in Segment 4, as a result of CCA, the result of CCA of the first subchannel (a subchannel located at the lowest frequency within the segment) indicated by the AP is determined as BUSY, and thus a 60 MHz RU except for the subchannel determined as BUSY cannot be utilized and transmission of the dynamic TB PPDU has been abandoned.

Accordingly, when it is indicated (by the AP) that the STA responding with a dynamic TB PPDU needs to mandatorily occupy a subchannel or a predetermined mandatory subchannel is configured, the AP may largely lighten the burden when performing an operation of receiving at least one preamble of the dynamic TB PPDUs simultaneously transmitted as responses. In this case, a mandatory subchannel of a primary 80 MHz segment may be fixed to a P20 channel. That is, when an STA having received allocation of an RU including a primary 20 MHz subchannel configures a dynamic TB PPDU, configuration of a dynamic TB PPDU not including the primary 20 MHz may be restricted.

Accordingly, the AP may lighten the burden of receiving a preamble by configuring a mandatory subchannel according to capability of the AP as described above, or limit the number of STAs allowed for the dynamic TB PPDU, so that the dynamic TB PPDU can be transmitted as a response within a range supported by the AP.

<Embodiment of Procedure of Reception of Dynamic TB PPDU>

The above-described dynamic TB PPDU-related embodiments describe an operation of an STA (AP and non-AP) and a format of a TB PPDU for the invention in which the AP acquires information required to receive the dynamic TB PPDU by decoding a preamble of a TB PPDU transmitted by each STA via UL.

Another implementation method of the present invention below provides a method for identifying, by an AP itself, a configuration an RU of a dynamic TB PPDU transmitted by each STA. According to an embodiment of the present invention below, an AP may identify a format of a TB PPDU received as a response to a trigger frame transmitted by the AP, on the basis of the strength of a received signal, and may configure the format with information on an RU allocated to each STA so as to identify the configuration of the RU of the dynamic TB PPDU transmitted by each STA via UL.

A detailed description of the dynamic TB PPDU reception method proposed in the present invention is made below. The AP has allocated an RU to each STA through the trigger frame, and may thus calculate a BW and reception time points of TB PPDUs for which reception is predicted, on the basis of information on the trigger frame generated by the AP. In addition, the AP may identify, in advance, information on the location at which a TB PPDU transmitted by each STA via UL is shown, among the TB PPDUs for which reception is predicted.

Accordingly, in consideration of a situation in which an AP knows the location of the RU of the TB PPDU to be transmitted by each STA, when the TB PPDU is received as a response to the trigger frame, an attempt to perform signal detection is made in subchannels for which it is predicted that the TB PPDU is shown, so that whether the predicted TB PPDU is shown or some subchannels are not utilized can be identified. In addition, it is identified that an RU allocated to a specific STA is not utilized, so that it can be recognized that the unutilized RU has been exclude from the TB PPDU configuration. As a simple example, after allocating an 80 MHz RU to a specific STA through a trigger frame, an AP may predict that an 80 MHz TB PPDU is transmitted as a response to the trigger frame. In this case, signal detection may be performed for four subchannels existing in the 80 MHz RU in which a response of the TB PPDU is expected, and as result of the signal detection, when signal detection is made for three subchannels only, it can be identified that the remaining one subchannel other than the three subchannel from which signal detection is made is a subchannel excluded in a process in which the STA configures a dynamic TB PPDU.

Accordingly, when the AP autonomously identifies a format of a TB PPDU transmitted by each STA as a response, STAs responding with the dynamic TB PPDU after reception of the trigger frame do not need to separately provide the AP with information related to an RU configuration of the dynamic TB PPDU transmitted by each of the STAs.

In another aspect of an effect acquired by utilizing the present invention, it is advantageous in that the AP can stop, on the basis of a result of signal detection for a received TB PPDU, performing additional processing for a TB PPDU for which it is determined that decoding is impossible, among TB PPDUs transmitted by respective STAs via UL.

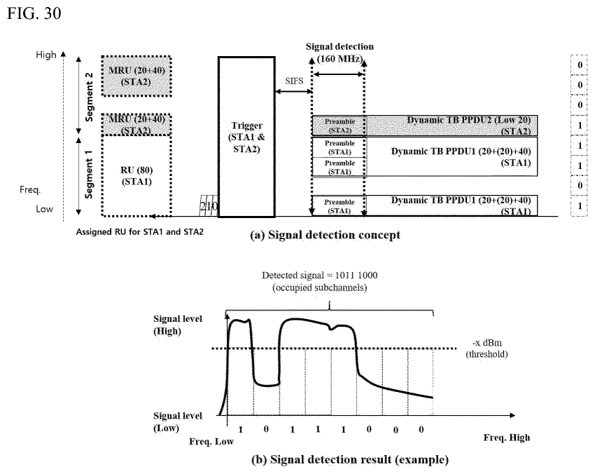

FIG. 30 illustrates an example of signal detection for a TB PPDU as a response to a trigger frame according to an embodiment of the present invention.

Referring to part (a) of FIG. 30, an AP has allocated an 80 MHz RU of Segment 1 and a 20+(20)+40 MHz RU of Segment 2 to STA1 and STA2, respectively, through a 160 MHz trigger frame (has allowed a dynamic TB PPDU response), and STA1 and STA2 having received the trigger frame respond with dynamic TB PPDUs 1 and 2, respectively.

In this case, the AP already knows that a TB PPDU is to be received through the 160 MHz BW after the trigger frame is transmitted by the AP itself, and may thus attempt to perform signal detection to identify configuration of an RU through which dynamic TB PPDUs are received. In this case, a signal detection method performed by the AP may be an operation similar to per 20 MHz CCA.

When performing the signal detection, the AP may utilize information on a timing of receiving a TB PPDU, as well as a BW of a TB PPDU which is predicted to be received. In the conventional 11ax standard, STAs having received allocation of an RU through a trigger frame need to respond with a TB PPDU after an SIFS by utilizing the allocated RU. In consideration of such time regulations for the TB PPDU response, after transmitting the trigger frame, the AP may predict that the TB PPDU is to be received after a specific time interval (e.g., an SIFS (+ propagation delay)) from a transmission end time point of the trigger frame.

Accordingly, the AP may specify a range (frequency and time) of the signal detection operation by utilizing precited BW information and precited reception timing information of TB PPDUs which are predicted to be received. In this case, the AP may attempt to perform signal detection for a part of a time period for which detection of a preamble of TB PPDUs is predicted, on the basis of the predicted reception timing information.

Part (b) of FIG. 30 illustrates an example of a detection result which can be acquired when an AP performs signal detection for a TB PPDU. As shown in the part (a) of FIG. 30, when STA1 and STA2 have responded with dynamic TB PPDUs 1 and 2 by utilizing a 20+(20)+40 MHz RU and a 20 MHz RU, respectively, a result of signal detection performed by the AP may show that a high signal level is measured in a subchannel utilized when each STA configures a dynamic TB PPDU, and a low signal level is measured for a subchannel not utilized in the dynamic TB PPDU transmission.

The AP may determine whether the TB PPDU starts to be received in each subchannel in consideration of strengths of signals detected from the respective subchannels. As a simple example, as shown in part (b) of FIG. 3, the AP may complete the signal detection on the basis of whether a signal detected from each subchannel exceeds a specific threshold value. In this case, the signal detection performed by the AP can be performed according to a timing of receiving a preamble of a TB PPDU, and thus unlike the general per 20 MHz CCA, the signal detection may be performed in a preamble detection (PD) scheme or an energy detection (ED) scheme, but may be performed by utilizing a value different from an ED threshold value for general PIFS-based channel access.

As described above, after identifying a subchannel in which the TB PPDU reception is started, by utilizing the signal detection, the AP may predict an RU configuration of a dynamic TB PPDU transmitted by each STA.

In FIG. 30, as a result of the signal detection, the AP may determine that the TB PPDU is indicated as 1011 in Segment 1 and is received as 1000 in Segment 2. In this case, since the 80 MHz RU of Segment 1 has been allocated by STA1 through the trigger frame, the AP may recognize that STA1 responds with the dynamic TB PPDU by utilizing a 20+(20)+40 MHz RU except for one subchannel among the allocated 80 MHz RU. In this case, determination on a dynamic TB PPDU format of STA2 may be also made in the same manner as the above-described process of identifying the dynamic TB PPDU of STA1.

The above-described process of identifying the dynamic TB PPDU format is simply described below in relation to the operation performed by the PHY of the AP. After receiving a request for trigger frame transmission from the MAC, the PHY of the AP may receive a RU_ALLOCATION_LIST and DYNAMIC_RU_LIST parameter, etc. transferred through TRIGVECTOR. Thereafter, the PHY attempts to perform signal detection of a TB PPDU according to a time for which a TB PPDU response is predicted, and determines whether a TB PPDU is received in each subchannel. In this case, the signal detection may be performed only to a subchannel in which a dynamic TB PPDU can be received, on the basis of information of the DYNAMIC_RU_LIST parameter.

The PHY of the AP may amend the RU configuration of the STA, identified through the RU_ALLOCATION_LIST, on the basis of the result of the signal detection, and consequently, even though the dynamic TB PPDU is transmitted as response by utilizing a configuration of an RU different from an RU allocated by the MAC through the trigger frame, the PHY may appropriately separate or decode a TB PPDU of each STA.

By utilizing the above-described embodiment of the present invention, the AP may autonomously receive the dynamic TB PPDU transmitted by each STA as a response, without performing additional signaling using the TB PPDU U-SIG. However, the above-described signal detection method in the part (b) of FIG. 30 may be somewhat inaccurate, which may cause an AP to fail to accurately determine a subchannel in which a TB PPDU is received. Accordingly, to increase accuracy of the above-described signal detection, a signal detection method for adaptively adjusting and applying a threshold value may be required.

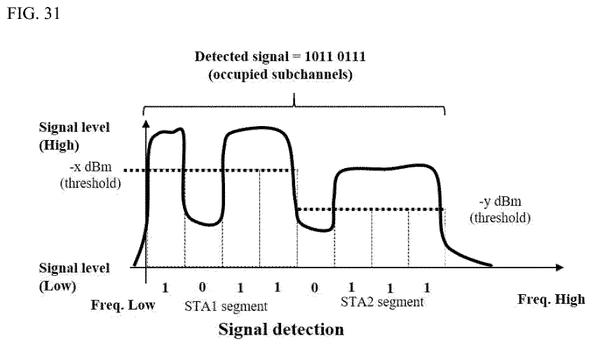

FIG. 31 illustrates an example of applying different threshold values to an area in which reception is predicted in a signal detection process for a TB PPDU according to an embodiment of the present invention.

Referring to FIG. 31, in the signal detection process of identifying whether a TB PPDU is received, different threshold values may be applied for an area in which TB PPDUs of different STAs are received.

In FIG. 31, an AP may perform signal detection by applying different threshold values to RUs allocated to different STAs. After the AP transmits a trigger frame, a situation in which it is predicted that TB PPDU1 of STA1 is transmitted to Segment1 as a response and it is predicted that TB PPDU2 of STA2 is transmitted to Segment2 as a response may be assumed. In this case, the AP may identify whether TB PPDU1 is indicated, by applying threshold value −x dBm to four subchannels for which reception of TB PPDU1 is predicted, and for four subchannels for which reception of TB PPDU2 is predicted, −y dBm may be applied as a threshold value.

The reason why different threshold values are utilized to detect TB PPDUs of different STAs is because the respective STAs having received the trigger frames may have different distances from the AP, and UL Target RSSI values indicated through the user info field of the trigger frame by the AP may be different.

When the AP has indicated to STA1 that the UL target RSSI is 90 and −20 dBm is satisfied, a signal received in −40 dBm may not be a signal detected from a TB PPDU transmitted by STA1 as a response. On the other hand, the AP has indicated to STA2 that the UL target RSSI is 0 and −110 dBm is satisfied, in a result of signal detection using −40 dBm as a threshold value, a TB PPDU signal transmitted by STA2 as a response may be ignored.

Accordingly, the AP may apply different threshold values to detect a TB PPDU transmitted by each STA as a response, in consideration of a target RSSI value indicated to each STA. To this end, the MAC of the AP may need to transfer RU (subchannel)_(target)RSSI_LIST to TRIGVECTOR transferred to the PHY.

According to the above-described embodiment of the present invention, signal detection may be performed for TB PPDUs each transmitted as a response, by using different target RSSI values. However, when signal interference occurs in some of subchannels in which signal detection is performed, due to another device, a result of the signal detection for some subchannels may be identified differently from an actual TB PPDU reception format.

In order to correct a signal detection error which may occur due to a signal of another device, the AP may determine whether a TB PPDU is shown, on the basis of a threshold value in the signal detection process, while additionally identifying a constant strength of a signal is received in subchannels for which TB PPDUs of respective STAs are transmitted as responses.

This is because when a PPDU transmitted by an STA (AP or non-AP) has a BW exceeding 20 MHz in the Wi-Fi standard, it is recommended that the strength of a signal emitted to each subchannel by the PPDU is to be constant (e.g., maximum deviation+−4 dB). Accordingly, where there is a subchannel having a signal, the strength of which is different by a predetermined level or higher from that of a signal identified in another subchannel, among signals identified in respective subchannels, the signal detected from the subchannel may be determined to be received from another device. In this case, the method for comparing strengths of signals and detecting a signal received from another device may be referred to as a method for detecting a signal detection error by using flatness of a signal.

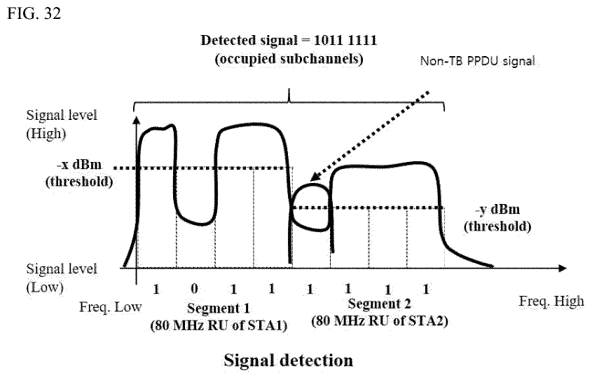

FIG. 32 illustrates an example of an error correction method signal detection according to an embodiment of the present invention.

Referring to FIG. 32, an AP performs signal detection to identify RU configurations of dynamic TB PPDUs of STA1 and STA2, and utilizes different threshold values for a subchannel for which reception of a TB PPDU of each STA is predicted.

In this case, from Segment2 for which reception of a TB PPDU of STA2 is 0 predicted, the AP may detect a non-TB PPDU signal exceeding a threshold value (−y dBm) configured to detect the TB PPDU of STA2.

However, among the signals detected from Segment2, the PHY of the AP may identify that the strength of a signal identified in the first subchannel (on the leftmost side in FIG. 32) is different from that of a signal identified from each of the remaining second, third, and fourth subchannels, and according to the identification, may identify that the signal detected from the first subchannel and the signals detected from the remaining subchannels are different. In this case, in order to identify whether a dynamic TB PPDU transmitted by STA2 via UL is a 20 MHz TB PPDU shown in the first subchannel or a 20+40 MHz TB PPDU utilizing the remaining three 0 subchannels, the AP may attempt to perform decoding for both PPDs.

Accordingly, according to an embodiment of the present invention, in order to identify an RU configuration of a dynamic TB PPDU transmitted by each STA, the AP may utilize signal detection, and errors which may be generated in the signal detection process can be corrected through an error detection technique using adaptive threshold value adjustment and flatness of a Wi-Fi signal.

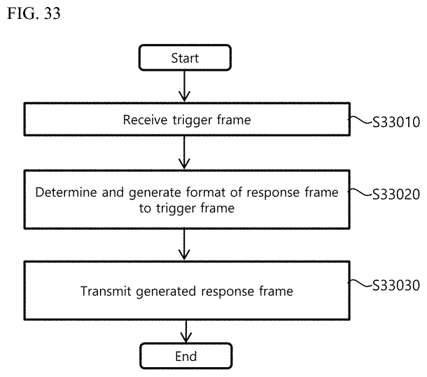

FIG. 33 is a flowchart illustrating an example of a method for transmitting a response frame to a trigger frame by a non-AP STA according to an embodiment of the present invention.

Referring to FIG. 33, when receiving a trigger frame indicating transmission of a TB PPDU, a non-AP STA may generate a TB PPDU according to a responding TB PPDU type and format and respond.

Specifically, a non-AP STA may receive a trigger frame indicating transmission of a TB PPDU from an AP (S33010). The trigger frame may include a common information field including first multiple spatial reuse fields. In addition, the trigger frame may additionally include an additional information field including second multiple spatial reuse fields, and whether the trigger frame includes the additional information field is identified on the basis of identification information of the trigger frame.

That is, whether the trigger frame includes the second multiple spatial reuse fields may be identified according to the identification information included in the trigger frame.

For example, as described above, the trigger frame may include first multiple spatial reuse fields (spatial reuse fields 1 to 4) in the common information field, and the trigger frame may include second multiple spatial reuse fields (spatial reuse fields 5 to 8) according to identification information (for example, whether a specific field value of the common information field is “1”, whether an AID value of the additional information field is “2007”, etc.).

A configuration of the trigger frame may be identical to the trigger format described in FIGS. 9 and 11. For example, the trigger frame may include at least one of a common information field, an additional information field, and a user information field, and a configuration of the additional information field and/or user information field may vary according to the type and/or the format of the trigger frame.

In this case, the user information field of each non-AP STA may be an EHT format or a HE format according to the format of the TB PPDU indicated by the trigger frame.

In this case, the first multiple spatial reuse fields may be used for generation of a HE TB PPDU when the location of an RU for transmission of a TB PPDU corresponding to a response to the trigger frame is a high frequency band (or primary BW) or the TB PPDU is the HE TB PPDU. That is, the first multiple spatial reuse fields may be encoded to spatial reuse fields of the TB PPDU.

The second multiple spatial reuse fields for spatial reuse for a second bandwidth included in the additional information field may be used for generation of an EHT TB PPDU when the location of an RU for transmission of a TB PPDU corresponding to a response to the trigger frame is a low frequency band (or primary BW or a secondary BW) or the TB PPDU is the EHT TB PPDU. That is, the second multiple spatial reuse fields may be encoded to spatial reuse fields of the TB PPDU.

Alternatively, the first multiple spatial reuse fields or the second multiple spatial reuse fields may be used for generation of the TB PPDU corresponding to a response frame according to the trigger frame-related format (for example, the format of the user information field).

For example, when the trigger frame-related format is a HE format (for example, when the format of the user information field is a HE format), the first multiple spatial reuse fields are used and a TB PPDU corresponding to a response frame is generated as a HE TB PPDU. However, when the trigger frame-related format is an EHT format (for example, when the format of the user information field is an EHT format), the second multiple spatial reuse fields are used and a TB PPDU corresponding a response frame is generated as an EHT TB PPDU.

Thereafter, the non-AP STA may generate, as a response to the trigger frame, a response frame on the basis of information acquired from the first multiple spatial reuse fields and the second multiple spatial reuse fields (S33020).

That is, the non-AP STA may determine the format of the response frame to the trigger frame and generate a TB PPDU corresponding to the response frame according to the determined format. In this case, the TB PPDU corresponding to the response frame may be generated on the basis of the information acquired from the first multiple spatial reuse fields or the second multiple spatial reuse fields. Whether the response frame is generated on the basis of the first multiple spatial reuse fields or is generated on the basis of the second multiple spatial reuse fields may be determined on the basis of the trigger frame-related format. For example, when the format of the user information field of the trigger frame is the HE format, the format of the TB PPDU may be determined as a HE TB PPDU and a response frame may be generated on the basis of the first multiple spatial reuse fields. That is, the response frame may be generated on the basis of information acquired from the first multiple spatial reuse fields or the second multiple spatial reuse fields.

The first multiple spatial reuse fields or the second multiple spatial reuse fields for generation of the TB PPDU may be also selected according to the location of an RU allocated for transmission of the TB PPDU indicated by the trigger frame. That is, when the location of the RU is a high frequency band (or a primary BW), the TB PPDU may be generated on the basis of the first multiple spatial reuse fields, and when the location of the RU is a low frequency band (or a secondary BW), the TB PPDU may be generated on the basis of the second multiple spatial reuse fields.

Thereafter, the non-AP STA may transmit the response frame generated on the basis of the information acquired from the first multiple spatial reuse fields or the second multiple reuse fields as a response to the trigger frame (S34030). Whether the response frame is generated on the basis of the first multiple spatial reuse fields or the second multiple spatial reuse fields may be determined on the basis of the trigger frame-related format.

When the trigger frame-related format is an extremely high throughput (EHT) format, the response frame may be generated on the basis of the second multiple spatial reuse fields.

In addition, when the trigger frame-related format is a high efficiency (HE) format, the response frame is generated on the basis of the information acquired from the first multiple spatial reuse fields.

In addition, whether the response frame is generated on the basis of the information acquired from the first multiple spatial reuse fields or is generated on the basis of the information acquired from the second multiple spatial reuse fields may be determined on the basis of the location on a frequency axis of a resource unit through which the response frame is transmitted.

The trigger frame may include at least one of a bandwidth field, an additional bandwidth field, a resource allocation field indicating a resource unit through which the response frame is transmitted, and a puncturing mode field indicating whether puncturing is performed in a bandwidth indicated by the bandwidth field and/or the additional bandwidth field, and the location of the puncturing.

In addition, the non-AP STA may recognize the resource unit through which the response frame is transmitted, on the basis of the resource allocation field included in the trigger frame. According to the location on the frequency axis of the resource unit through which the response frame is transmitted, the response frame may be generated on the basis of the information acquired from the first multiple spatial reuse fields or the second multiple spatial reuse fields.

When the response frame is generated on the basis of the second multiple spatial reuse fields, the response frame may be transmitted through a bandwidth indicated by a bandwidth field included in the common information field and an additional bandwidth field included in the additional information field.

The response frame may include multiple spatial reuse fields, and each of the multiple spatial reuse fields may be configured on the basis of the information acquired from each of the first multiple spatial reuse fields or the second multiple spatial reuse fields.

Whether the trigger frame includes the additional information field may be recognized according to whether a value of a specific subfield indicating whether the common information field includes the additional information field and/or a value of an identifier of the additional information field is configured as a specific value.

In addition, as described above, the response frame may be transmitted in the format of a TB PPDU, and the TB PPDU may be aggregated with at least one TB PPDU transmitted from at least one another non-AP STA for which transmission of the TB PPDU is indicated by the trigger frame and may be transmitted in the format of an aggregated (A)-PPDU. In this case, at least one TB PPDU is generated on the basis of the first multiple spatial reuse fields or the second multiple spatial reuse fields, and the TB PPDU and the at least one of TB PPDU are generated on the basis of different spatial reuse fields.

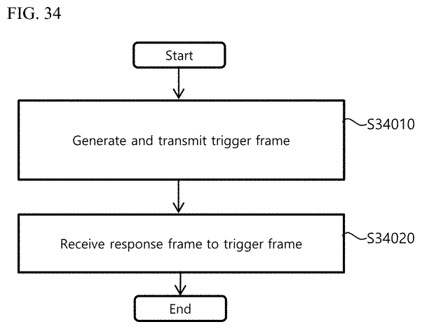

FIG. 34 is a flowchart illustrating an example of a method for receiving a response frame for a trigger frame by an AP STA according to an embodiment of the present invention.

Referring to FIG. 34, an AP may transmit a trigger frame indicating transmission of a TB PPDU, and receive a TB PPDU a response to the trigger frame from one or more non-AP STAs. In this case, when there are two or more TB PPDUs transmitted from the one or more non-AP STAs, the TB PPDUs are aggregated and transmitted in a A-PPDU format. In addition, the TB PPDUs may have different formats (for example, a HE TB PPDU, an EHT TB PPDU, etc.).

Specifically, the AP may generate and transmit a trigger frame indicating transmission of a TB PPDU (S34010). The trigger frame may include a common information field including first multiple spatial reuse frames. In addition, the trigger frame may additionally include an additional information field including second multiple spatial reuse fields, and whether the trigger frame includes the additional information field is identified on the basis of identification information of the trigger frame.

That is, whether the trigger frame includes the second multiple spatial reuse fields may be identified according to the identification information included in the trigger frame.

For example, as described above, the trigger frame may include first multiple spatial reuse fields (spatial reuse fields 1 to 4) in the common information field, and the trigger frame may include an additional information field including second multiple spatial reuse fields (spatial reuse fields 5 to 8) according to identification information (for example, whether a specific field value of the common information field is “1”, whether an AID value of the additional information field is “2007”, etc.).

A configuration of the trigger frame may be identical to the trigger format described in FIGS. 9 and 11. For example, the trigger frame may include at least one of a common information field, an additional information field, and a user information field, and a configuration of the additional information field and/or user information field may vary according to the type and/or the format of the trigger frame.

In this case, the user information field of each non-AP STA may be an EHT format or a HE format according to the format of the TB PPDU indicated by the trigger frame.

In this case, the first multiple spatial reuse fields included in the common information field may be used for generation of a HE TB PPDU when the location of an RU for transmission of a TB PPDU corresponding to a response to the trigger frame is a high frequency band (or primary BW) or the TB PPDU is the HE TB PPDU. That is, the first multiple spatial reuse fields may be encoded to spatial reuse fields of the TB PPDU.

The second multiple spatial reuse fields for spatial reuse for a second bandwidth included in the additional information field may be used for generation of an EHT TB PPDU when the location of an RU for transmission of a TB PPDU corresponding to a response to the trigger frame is a low frequency band (or primary BW or a secondary BW) or the TB PPDU is the EHT TB PPDU. That is, the second multiple spatial reuse fields may be encoded to spatial reuse fields of the TB PPDU.

Alternatively, the first multiple spatial reuse fields or the second multiple spatial reuse fields may be used for generation of the TB PPDU corresponding to a response frame according to a trigger frame-related format (for example, the format of the user information field).

For example, when the trigger frame-related format is a HE format (for example, when the format of the user information field is a HE format), the first multiple spatial reuse fields are used and a TB PPDU corresponding to a response frame is generated as a HE TB PPDU. However, when the trigger frame-related format is an EHT format (for example, when the format of the user information field is an EHT format), the second multiple spatial reuse fields are used and a TB PPDU corresponding a response frame is generated as an EHT TB PPDU.

Thereafter, the AP may receive at least one response frame (TB PPDU) from one or more non-AP STAs, as a response to the trigger frame (S34020). In this case, the TB PPDU may be generated on the basis of information acquired from the first multiple spatial reuse fields or the second multiple spatial reuse fields.

The TB PPDU corresponding to the response frame may be generated on the basis of the information acquired from the first multiple spatial reuse fields or the second multiple spatial reuse fields. Whether the response frame is generated on the basis of the first multiple spatial reuse fields or is generated on the basis of the second multiple spatial reuse fields may be determined on the basis of the trigger frame-related format. For example, when the format of the user information field of the trigger frame is the HE format, the format of the TB PPDU may be determined as a HE TB PPDU and a response frame may be generated on the basis of the first multiple spatial reuse fields. That is, the response frame may be generated on the basis of information acquired from the first multiple spatial reuse fields or the second multiple spatial reuse fields.

The first multiple spatial reuse fields or the second multiple spatial reuse fields for generation of the TB PPDU may be also selected according to the location of an RU allocated for transmission of the TB PPDU indicated by the trigger frame. That is, when the location of the RU is a high frequency band (or a primary BW), the TB PPDU may be generated on the basis of the first multiple spatial reuse fields, and when the location of the RU is a low frequency band (or a secondary BW), the TB PPDU may be generated on the basis of the second multiple spatial reuse fields.

Whether the response frame is generated on the basis of the first multiple spatial reuse fields or the second multiple spatial reuse fields may be determined on the basis of the trigger frame-related format.

When the trigger frame-related format is an extremely high throughput (EHT) format, the response frame may be generated on the basis of the second multiple spatial reuse fields.

In addition, when the trigger frame-related format is a high efficiency (HE) format, the response frame is generated on the basis of the information acquired from the first multiple spatial reuse fields. That is, the response frame may be generated on the basis of the information acquired from the first multiple spatial reuse fields or the second multiple spatial reuse fields.

The first multiple spatial reuse fields or the second multiple spatial reuse fields for generation of the TB PPDU may be also selected according to the location of an RU allocated for transmission of the TB PPDU indicated by the trigger frame. That is, when the location of the RU is a high frequency band (or a primary BW), the TB PPDU may be generated on the basis of the first multiple spatial reuse fields, and when the location of the RU is a low frequency band (or a secondary BW), the TB PPDU may be generated on the basis of the second multiple spatial reuse fields.

When the trigger frame-related format is an extremely high throughput (EHT) format, the response frame may be generated on the basis of the second multiple spatial reuse fields.

In addition, when the trigger frame-related format is a high efficiency (HE) format, the response frame is generated on the basis of the information acquired from the first multiple spatial reuse fields.

In addition, whether the response frame is generated on the basis of the information acquired from the first multiple spatial reuse fields or is generated on the basis of the information acquired from the second multiple spatial reuse fields may be determined on the basis of the location on a frequency axis of a resource unit through which the response frame is transmitted.

The trigger frame may include at least one of a bandwidth field, an additional bandwidth field, a resource allocation field indicating a resource unit through which the response frame is transmitted, and a puncturing mode field indicating whether puncturing is performed in a bandwidth indicated by the bandwidth field and/or the additional bandwidth field, and the location of the puncturing.

In addition, the non-AP STA may recognize the resource unit through which the response frame is transmitted, on the basis of the resource allocation field included in the trigger frame, and according to the location on the frequency axis of the resource unit through which the response frame is transmitted, the response frame may be generated on the basis of the information acquired from the first multiple spatial reuse fields or the second multiple spatial reuse fields.

When the response frame is generated on the basis of the second multiple spatial reuse fields, the response frame may be transmitted through a bandwidth indicated by a bandwidth field included in the common information field and an additional bandwidth field included in the additional information field.

The response frame may include multiple spatial reuse fields, and each of the multiple spatial reuse fields may be configured on the basis of the information acquired from each of the first multiple spatial reuse fields or the second multiple spatial reuse fields.

Whether the trigger frame includes the additional information field may be recognized according to whether a value of a specific subfield indicating whether the common information field includes the additional information field and/or a value of an identifier of the additional information field is configured as a specific value.

In addition, as described above, the response frame may be transmitted in the format of a TB PPDU, and the TB PPDU may be aggregated with at least one TB PPDU transmitted from at least one another non-AP STA for which transmission of the TB PPDU is indicated by the trigger frame and may be transmitted in the format of an aggregated (A)-PPDU. In this case, at least one TB PPDU is generated on the basis of the first multiple spatial reuse fields or the second multiple spatial reuse fields, and the TB PPDU and the at least one of TB PPDU are generated on the basis of different spatial reuse fields.

The aforementioned description of the present invention is merely provided as an example, and it will be understood by those skilled in the art that modifications into other particular forms can be made without changing the essential characteristics or the technical idea of the present invention. Therefore, it is to be understood that the aforementioned exemplary embodiments are all illustrative in all aspects and are not limited. For example, each element described as a single type may be implemented to be distributed and similarly, elements described to be distributed may also be implemented in a combined form.

The scope of the present invention is represented by the claims to be described below rather than the detailed description, and it is to be interpreted that the meaning and scope of the claims and all the changes or modified forms derived from the equivalents thereof come within the scope of the present invention.

1. A terminal in a wireless communication system, the terminal comprising:
a communication module; and
a processor configured to control the communication module,
wherein the processor is configured to,
receive a trigger frame from an access point (AP), wherein the trigger frame comprises a common information field comprising a first plurality of spatial reuse fields, and
wherein whether the trigger frame includes an additional information field including a second plurality of spatial reuse fields is identified on the basis of identification information of the trigger frame, and
transmit a response frame generated on the basis of information acquired from the first plurality of spatial reuse fields or the second plurality of spatial reuse fields, as a response to the trigger frame,
wherein whether the response frame is generated on the basis of the first plurality of spatial reuse fields or is generated on the basis of the second plurality of spatial reuse fields is determined on the basis of a format related to the trigger frame.

2. The terminal of claim 1, wherein when the format related to the trigger frame is an extremely high throughput (EHT) format, the response frame is generated on the basis of information acquired from the second plurality of spatial reuse fields.

3. The terminal of claim 1, wherein when the format related to the trigger frame is a high efficiency (HE) format, the response frame is generated on the basis of information acquired from the first plurality of spatial reuse fields.

4. The terminal of claim 1, wherein whether the response frame is generated on the basis of the information acquired from the first plurality of spatial reuse fields or is generated on the basis of the information acquired from the second plurality of spatial reuse fields is determined on the basis of a location on a frequency axis of a resource unit in which the response frame is transmitted.

5. The terminal of claim 1, wherein the trigger frame further comprises a bandwidth field, an additional bandwidth field, and a resource allocation field indicating a resource unit in which the response frame is transmitted.

6. The terminal of claim 5, wherein the processor is further configured to,
recognize, on the basis of the resource allocation field, the resource unit in which the response frame is transmitted, and
generate a response frame on the basis of the information acquired from the first plurality of spatial reuse fields or the second plurality of spatial reuse fields according to a location on a frequency axis of the resource unit in which the response frame is transmitted.

7. The terminal of claim 5, wherein the trigger frame further comprises a puncturing mode field indicating whether puncturing in a bandwidth indicated by the bandwidth field and/or the additional bandwidth field is performed and a location of the puncturing.

8. The terminal of claim 1, wherein when the response frame is generated on the basis of the second plurality of spatial reuse fields, the response frame is transmitted through a bandwidth indicated by a bandwidth field included in the common information field and an additional bandwidth field included in the additional information field.

9-11. (canceled)

12. A method for transmitting data by a terminal in a wireless communication system, the method comprising:
receiving a trigger frame from an access point (AP), wherein the trigger frame comprises a common information field comprising a first plurality of spatial reuse fields, and
wherein whether the trigger frame includes an additional information field including a second plurality of spatial reuse fields is identified on the basis of identification information of the trigger frame; and
transmitting a response frame generated on the basis of information acquired from the first plurality of spatial reuse fields or the second plurality of spatial reuse fields, as a response to the trigger frame,
wherein whether the response frame is generated on the basis of the first plurality of spatial reuse fields or is generated on the basis of the second plurality of spatial reuse fields is determined on the basis of a format related to the trigger frame.

13. The method of claim 12, wherein when the format related to the trigger frame is an extremely high throughput (EHT) format, the response frame is generated on the basis of information acquired from the second plurality of spatial reuse fields.

14. The method of claim 12, wherein when the format related to the trigger frame is a high efficiency (HE) format, the response frame is generated on the basis of information acquired from the first plurality of spatial reuse fields.

15. The method of claim 12, wherein whether the response frame is generated on the basis of the information acquired from the first plurality of spatial reuse fields or is generated on the basis of the information acquired from the second plurality of spatial reuse fields is determined on the basis of a location on a frequency axis of a resource unit in which the response frame is transmitted.

16. The method of claim 12, wherein the trigger frame further comprises a bandwidth field, an additional bandwidth field, and a resource allocation field indicating a resource unit in which the response frame is transmitted.

17. The method of claim 16, further comprising:
recognizing, on the basis of the resource allocation field, the resource unit in which the response frame is transmitted; and
generating a response frame on the basis of the information acquired from the first plurality of spatial reuse fields or the second plurality of spatial reuse fields according to a location on a frequency axis of the resource unit in which the response frame is transmitted.

18. The method of claim 16, wherein the trigger frame further comprises a puncturing mode field indicating whether puncturing in a bandwidth indicated by the bandwidth field and/or the additional bandwidth field is performed and a location of the puncturing.

19. The method of claim 12, wherein when the response frame is generated on the basis of the second plurality of spatial reuse fields, the response frame is transmitted through a bandwidth indicated by a bandwidth field included in the common information field and an additional bandwidth field included in the additional information field.

20-22. (canceled)
